(19) United States
(12) Patent Application Publication
(10) Pub. No.: US 2023/0278031 A1
(43) Pub. Date: Sep. 7, 2023

(54) DEVICES, SYSTEMS, AND METHODS FOR DIRECTING FLUID FLOW

(71) Applicant: 10x Genomics, Inc., Pleasanton, CA (US)

(72) Inventors: Francis MARCOGLIESE, Livermore, CA (US); Yiran ZHANG, Castro Valley, CA (US)

(21) Appl. No.: 18/154,516

(22) Filed: Jan. 13, 2023

Related U.S. Application Data
(60) Provisional application No. 63/299,600, filed on Jan. 14, 2022.

(51) Int. Cl. B01L 3/00

(52) U.S. Cl. CPC B01L 3/502715; B01L 3/523; B01L 3/527; B01L 3/502738; B01L 2200/16; B01L 2300/021

(57) ABSTRACT

Devices, systems, and methods for directing fluid flow to one or more specific regions of interest within a closed flow cell are provided. A device includes a first directing channel having a first directing proximal portion and a first directing distal portion, a second directing channel having a second directing proximal portion and a second directing distal portion, an inlet channel having an inlet proximal portion and an inlet distal portion, a reaction chamber, and a waste outlet. The inlet distal portion is disposed between the first directing distal portion and the second directing distal portion. The first directing distal portion, the second directing distal portion, and the inlet channel may be substantially parallel. The first directing channel, the second directing channel, the first reagent channel, and the waste outlet are in fluid communication with the reaction chamber.

### BACKGROUND

Many biological and biophysical assays require contacting biological samples with one or more fluids containing reagents. For example, sequencing and imaging assays both require contacting a sample with one or more reagents. These samples can be contained within a closed flow cell. Controlling and directing the flow of reagent liquids to particular regions of interest can improve reagent efficiency and reduce cost and/or enable multiple assays to be conducted on a single sample or within a single flow cell.

New devices, systems, and methods for directing fluid flow would be beneficial.

### BRIEF SUMMARY

In general, the present disclosure relates to devices, methods, and systems for directing fluid flow, e.g., within a closed flow cell.

In one aspect, devices (e.g., closed flow cells) are provided for directing the flow of one or more liquids. The device includes (a) a first directing channel including a first directing proximal portion and a first directing distal portion; (b) a second directing channel including a second directing proximal portion and a second directing distal portion; (c) an inlet channel including an inlet proximal portion and an inlet distal portion; (d) a reaction chamber; and (e) a waste outlet, wherein the inlet distal portion is disposed between the first directing distal portion and the second directing distal portion; the first directing distal portion, the second directing distal portion, and the inlet distal portion are in fluid communication with the reaction chamber; and the waste outlet is in fluid communication with the reaction chamber.

In one aspect, methods are provided for directing flow in a reaction chamber. The method includes: providing a device (e.g., closed flow cell) including a first directing channel including a first directing proximal portion and a first directing distal portion, a second directing channel including a second directing proximal portion and a second directing distal portion, an inlet channel including an inlet proximal portion and an inlet distal portion, a reaction chamber including a sample, and a waste outlet, wherein the inlet distal portion is disposed between the first directing distal portion and the second directing distal portion; the first directing distal portion, the second directing distal portion, and the inlet distal portion are in fluid communication with the reaction chamber; and the waste outlet is in fluid communication with the reaction chamber; flowing a first liquid from the inlet channel to the reaction chamber at a first flow rate, flowing a second liquid from the first directing channel to the reaction chamber at a second flow rate, and flowing a third liquid from the second directing channel to the reaction chamber at a third flow rate, wherein the first, second, and third flow rates direct the first liquid to a first region of interest in the sample, wherein the first region of interest is smaller than the area of the sample.

In one aspect, systems are provided for directing the flow of one or more liquids. The system includes a device (e.g., closed flow cell) including a first directing channel including a first directing proximal portion and a first directing distal portion, a second directing channel including a second directing proximal portion and a second directing distal portion, an inlet channel including an inlet proximal portion and an inlet distal portion, a reaction chamber, and a waste outlet; a controller capable of controlling the flow rate of liquids into the device; and a computing device operatively linked to the device and the controller, and wherein the computing device is configured to control the flow rate of a first liquid in the inlet channel, the flow rate of a second liquid in the first directing channel, and the flow rate of a third liquid in second directing channel to direct the flow of the first liquid to a first region of interest in the reaction chamber, wherein the first region of interest is smaller than the area of the reaction chamber.

In some embodiments of any aspect, the device further includes at least one reagent channel in fluid communication with the inlet channel. In some embodiments, the at least one reagent channel includes a plurality of reagent channels. In some embodiments, the device further includes one or more (e.g., 1, 2, 3, 4, 5, 6, 7, 8, 9, 10, 11, 12, 13, 14, 15, 16, 17, 18, 19, 20, 25, 30, 35, 40, 45, 50, or more) additional reagent channels. In some embodiments, the device further includes at least one reagent reservoir in fluid communication with the at least one reagent channel. In some embodiments, the device further includes one or more (e.g., 1, 2, 3, 4, 5, 6, 7, 8, 9, 10, 11, 12, 13, 14, 15, 16, 17, 18, 19, 20, 25, 30, 35, 40, 45, 50, or more) additional reagent reservoirs. In some embodiments, the at least one reagent reservoir includes a plurality of reagent reservoirs, and each reagent reservoir of the plurality of reagent reservoirs is in fluid communication with a corresponding reagent channel of the plurality of reagent channels (e.g., a first reagent reservoir is in fluid communication with a first reagent channel, a second reagent reservoir is in fluid communication with a second reagent channel, a third reagent reservoir is in fluid communication with a third reagent channel, etc.; e.g., the n^{th} reagent reservoir is in fluid communication with the n^{th} reagent channel). In some embodiments, the device further includes one or more reagent reservoirs. In some embodiments, the device includes one or more connections for fluid communication with the one or more reagent reservoirs.

In some embodiments, each reagent channel of the plurality of reagent channels is in fluid communication with the inlet channel.

In some embodiments, the first directing distal portion and the second directing distal portion are each disposed at a distance of about 100 μm to about 5 mm from the inlet channel.

In some embodiments, the device further includes an inlet region, wherein: the first directing distal portion, the second directing distal portion, and the inlet distal portion are in fluid communication with the inlet region; and the inlet region is in fluid communication with the reaction chamber. In some embodiments, the first directing distal portion, the second directing distal portion, and the inlet distal portion are in fluid communication with a proximal side of the reaction chamber, and the waste outlet is in fluid communication with a distal side of the reaction chamber (e.g., wherein the distal side is opposite the proximal side).

In some embodiments, the device further includes at least one valve disposed along at least one of: the first directing distal portion, the second directing distal portion, and the inlet channel. In some embodiments, the device further includes at least one valve disposed along the waste outlet.

In some embodiments, the device is a microfluidic device.

In some embodiments, the device further includes a first directing reservoir in fluid communication with the first directing proximal portion and/or a second directing reservoir in fluid communication with the second directing proximal portion.

In some embodiments, the reaction chamber of the device includes a lid that is separable from the device. In some embodiments, the lid is glass or plastic. In some embodiments, the reaction chamber includes a sample. In some embodiments, the reaction chamber includes a sample holder. In some embodiments, the sample holder includes a sample. In some embodiments, the sample holder is separable from the device. In some embodiments, the lid includes the sample holder. In some embodiments, the sample holder is glass or plastic.

In some embodiments, the reaction chamber of the device includes an optically transparent window. In some embodiments, the lid of the reaction chamber includes the optically transparent window. In some embodiments, the optically transparent window may be made from suitable materials, including glass, quartz, polystyrene, polyethylene terephthalate, etc.

In some embodiments, the method further includes flowing one or more additional liquids from the inlet channel to the reaction chamber at the first flow rate, flowing the second liquid from the first directing channel to the reaction chamber at the second flow rate, and flowing the third liquid from the second directing channel to the reaction chamber at the third flow rate, wherein the first, second, and third flow rates direct the one or more additional liquids to the first region of interest

In some embodiments, the method further includes flowing a fourth liquid from the inlet channel to the reaction chamber at the first flow rate, flowing the second liquid from the first directing channel to the reaction chamber at the second flow rate, and flowing the third liquid from the second directing channel to the reaction chamber at the third flow rate, wherein the first, second, and third flow rates direct the fourth liquid to the first region of interest.

In some embodiments, the first liquid includes a reagent for detecting a nucleic acid in the sample. In some embodiments, the reagent is for a nucleic acid sequencing reaction. In some embodiments, the reagent is for a DNA sequencing reaction or an RNA sequencing reaction. In some embodiments, the reagent is for in situ hybridization (ISH). In some embodiments, the reagent is for fluorescence in situ hybridization (FISH).

In some embodiments, the first liquid includes a reagent for detecting a protein in the sample. In some embodiments, the reagent is for immunohistochemistry (IHC).

In some embodiments, the first liquid includes a reagent for an enzymatic reaction.

In some embodiments, the first liquid includes a reagent for a chemical reaction.

In some embodiments, reagents are selected from antibodies, buffers, enzymes, chelators, nucleotides, oligonucleotides, dyes, chemical crosslinkers, permeabilization reagents, clearing reagents, quenchers, and salts. In some embodiments, enzymes are selected from polymerases, ligases, nuclease inhibitors, and proteases. In some embodiments, oligonucleotides include primers and/or nucleic acid probes. In some embodiments, the nucleic acid probes are detectably labeled.

In some embodiments, the first liquid is miscible with water. In some embodiments, the first liquid is aqueous. In some embodiments, the second and third liquids are not miscible with water. In some embodiments, the first liquid is not miscible with the second liquid or the third liquid. In some embodiments, the second and third liquids are the same. In some embodiments, the second and third liquids are oils. In some embodiments, the fourth liquid is miscible with water.

In some embodiments, the sample can be removed from the reaction chamber. In some embodiments, the sample is a biological sample. In some embodiments, the biological sample is a tissue sample. In some embodiments, the method further includes taking one or more (e.g., 1, 2, 3, 4, 5, 6, 7, 8, 9, 10, 11, 12, 13, 14, 15, 16, 17, 18, 19, 20, 25, 30, 35, 40, 45, 50, or more) measurements of the first region of interest.

In some embodiments, the sample further includes a second region of interest, and the method further includes flowing the first liquid from the inlet channel to the reaction chamber at a fourth flow rate, flowing the second liquid from the first directing channel to the reaction chamber at a fifth flow rate, and flowing the third liquid from the second directing channel to the reaction chamber at the sixth flow rate, wherein the fourth, fifth, and sixth flow rates direct the first liquid to the second region of interest.

In some embodiments, the method further includes taking one or more (e.g., 1, 2, 3, 4, 5, 6, 7, 8, 9, 10, 11, 12, 13, 14, 15, 16, 17, 18, 19, 20, 25, 30, 35, 40, 45, 50, or more) measurements of the second region of interest.

In some embodiments, the second and third flow rates determine the position of the first region of interest. In some embodiments, the second and third flow rates are the same. In some embodiments, the second and third flow rates are different. In some embodiments, the second flow rate is greater than the third flow rate by about 1%, 2%, 3%, 4%, 5%, 6%, 7%, 8%, 9%, 10%, 15%, 20%, 25%, 30%, 35%, 40%, 45%, 50%, 60%, 70%, 80%, 90%, 100%, 110%, 120%, 130%, 140%, 150%, 160%, 170%, 180%, 190%, 200%, 225%, 250%, 275%, 300%, 350%, 400%, 450%, 500%, 550%, 600%, 650%, 700%, 800%, 900%, 1000%, or more). In some embodiments, the third flow rate is greater than the second flow rate by about 1%, 2%, 3%, 4%, 5%, 6%, 7%, 8%, 9%, 10%, 15%, 20%, 25%, 30%, 35%, 40%, 45%, 50%, 60%, 70%, 80%, 90%, 100%, 110%, 120%, 130%, 140%, 150%, 160%, 170%, 180%, 190%, 200%, 225%, 250%, 275%, 300%, 350%, 400%, 450%, 500%, 550%, 600%, 650%, 700%, 800%, 900%, 1000%, or more). In some embodiments, the first liquid flows away from the directing channel having the higher flow rate.

In some embodiments, the fifth and sixth flow rates determine the position of the second region of interest. In some embodiments, the fifth and third flow rates are the same. In some embodiments, the fifth and sixth flow rates are different. In some embodiments, the fifth flow rate is greater than the sixth flow rate by about 1%, 2%, 3%, 4%, 5%, 6%, 7%, 8%, 9%, 10%, 15%, 20%, 25%, 30%, 35%, 40%, 45%, 50%, 60%, 70%, 80%, 90%, 100%, 110%, 120%, 130%, 140%, 150%, 160%, 170%, 180%, 190%, 200%, 225%, 250%, 275%, 300%, 350%, 400%, 450%, 500%, 550%, 600%, 650%, 700%, 800%, 900%, 1000%, or more. In some embodiments, the sixth flow rate is greater than the fifth flow rate by about 1%, 2%, 3%, 4%, 5%, 6%, 7%, 8%, 9%, 10%, 15%, 20%, 25%, 30%, 35%, 40%, 45%, 50%, 60%, 70%, 80%, 90%, 100%, 110%, 120%, 130%, 140%, 150%, 160%, 170%, 180%, 190%, 200%, 225%, 250%, 275%, 300%, 350%, 400%, 450%, 500%, 550%, 600%, 650%, 700%, 800%, 900%, 1000%, or more. In some embodiments, the first liquid flows away from the directing channel having the higher flow rate.

In some methods, (i) the first and fourth flow rates are different; (ii) the second and fifth flow rates are different; and/or (iii) the third and sixth flow rates are different. In some embodiments, only one, only two, or all 3 of the options (i), (ii), and (iii) above are true. In some embodiments, when at least one of the options (i), (ii), and (iii) above is true, the first and second regions of interest are different.

In some embodiments, the system further includes a computing device including a user interface for selecting the first region of interest of a sample in the reaction chamber.

In some embodiments, the system further includes the inlet channel including a first liquid; the first directing channel including a second liquid; and the second directing channel including a third liquid, and wherein the first liquid is immiscible with the second and third liquids. In some embodiments, any of the additional reagent channels and/or additional reagent reservoirs may include a liquid that is miscible with the first liquid. In some embodiments, any of the additional reagent channels and/or additional reagent reservoirs may include the first liquid.

In some embodiments, the sample in the reaction chamber further includes a second region of interest, and wherein the computing device is configured to control the flow rate of a first liquid in the inlet channel, the flow rate of a second liquid in the first directing channel, and the flow rate of a third liquid in second directing channel to direct the flow of the first liquid to a second region of interest in the reaction chamber, wherein the second region of interest is smaller than the area of the reaction chamber, and wherein the second region of interest is different from the first region of interest. In some embodiments, the flow rates of the first and second directing channels are different when directing flow of the first liquid to the first region of interest from when directing flow of the first liquid to the second region of interest.

### BRIEF DESCRIPTION OF THE DRAWINGS

FIG. 1A-FIG. 1D are schematics of exemplary devices (e.g., closed flow cells) for directing reagent flow to a specific region of interest of a sample (107) disposed within the device, according to embodiments of the disclosure, which includes the first (103a) and second (103b) directing channels, the inlet channel (114), as well as the first (113a), second (113b), and third (113c) reagent channels, each (directly or indirectly) in fluid communication with the reaction chamber (106). In the exemplary device, the second (113a) and third reagent channels (113c) both intersect the first reagent channel (113a). The first (113a), second (113b), and third (113c) reagent channels are in fluid communication with the inlet channel (114), which includes an inlet proximal portion and an inlet distal portion, and the inlet distal portion is disposed between the first directing distal portion (104a) and the second directing distal portion (104b). The distal portions of the channels are closer to the reaction chamber than the proximal portions. The reaction chamber is also in fluid communication with a waste outlet.

FIG. 2 is a schematic demonstrating an exemplary method of directing liquid flow within a device, according to embodiments of the disclosure. The device includes a reaction chamber (206), which includes a tissue sample (diamond shape; 207). As shown, an aqueous liquid flows from the topmost reagent channel (213a), a second liquid flows from the first directing channel (203a), and a third liquid flows from the second directing channel (203b), all into the reaction chamber (big circle; 206). The second liquid (202a) and the third liquid (202b) have volumetric flow rates q1 and q2, respectively. In this example, q1 is higher than q2, and thus the flow of the aqueous liquid is directed downwards across the lower portion of the tissue sample, across the region of interest (217).

### DETAILED DESCRIPTION

The disclosure provides devices, methods, and systems for directing fluid flow, e.g., in a flow cell. In particular, the devices, methods, and systems direct fluid flow to one or more particular regions of interest of a sample (e.g., a biological sample), e.g., to perform a variety of analyses.

### Definitions

The following definitions are provided for specific terms:

Where values are described as ranges, it will be understood that such disclosure includes the disclosure of all possible sub-ranges within such ranges, as well as specific numerical values that fall within such ranges irrespective of whether a specific numerical value or specific sub-range is expressly stated.

The term “about,” as used herein, refers to ±10% of a recited value.

The terms “adaptor(s),” “adapter(s),” and “tag(s)” may be used synonymously. An adaptor or tag can be coupled to a polynucleotide sequence to be “tagged” by any approach including ligation, hybridization, or other approaches.

The term “barcode,” as used herein, generally refers to a label, or identifier, that conveys or is capable of conveying information about an analyte. A barcode can be part of an analyte. A barcode can be a tag attached to an analyte (e.g., nucleic acid molecule) or a combination of the tag in addition to an endogenous characteristic of the analyte (e.g., size of the analyte or end sequence(s)). A barcode may be unique. Barcodes can have a variety of different formats. For example, barcodes can include: polynucleotide barcodes; random nucleic acid and/or amino acid sequences; and synthetic nucleic acid and/or amino acid sequences. A barcode can be attached to an analyte in a reversible or irreversible manner. A barcode can be added to, for example, a fragment of a deoxyribonucleic acid (DNA) or ribonucleic acid (RNA) sample before, during, and/or after sequencing of the sample. Barcodes can allow for identification and/or quantification of individual sequencing-reads in real time.

The term “flow path,” as used herein, refers to a path of channels and other structures for liquid flow from at least one inlet to at least one outlet. A flow path may include branches and may connect to adjacent flow paths, e.g., by a common inlet or a connecting channel.

The term “fluidically connected,” as used herein, refers to a direct connection between at least two device elements, e.g., a channel, reservoir, etc., that allows for fluid to move between such device elements without passing through an intervening element.

The term “fluidically disposed between,” as used herein, refers to the location of one element between two other elements so that fluid can flow through the three elements in one direction of flow.

The term “genome,” as used herein, generally refers to genomic information from a subject, which may be, for example, at least a portion or an entirety of a subject's hereditary information. A genome can be encoded either in DNA or in RNA. A genome can include coding regions that code for proteins as well as non-coding regions. A genome can include the sequence of all chromosomes together in an organism. For example, the human genome has a total of 46 chromosomes. The sequence of all of these together may constitute a human genome.

The term “in fluid communication with”, as used herein, refers to a connection between at least two device elements, e.g., a channel, reservoir, etc., that allows for fluid to move between such device elements with or without passing through one or more intervening device elements. When two compartments in fluid communication are directly connected, i.e., connected in a manner allowing fluid exchange without necessity for the fluid to pass through any other intervening compartment, the two compartments are deemed to be fluidically connected.

The term “macromolecular constituent,” as used herein, generally refers to a macromolecule contained within or from a biological particle. The macromolecular constituent may include a nucleic acid. In some cases, the biological particle may be a macromolecule. The macromolecular constituent may include DNA or a DNA molecule. The macromolecular constituent may include RNA or an RNA molecule. The RNA may be coding or non-coding. The RNA may be messenger RNA (mRNA), ribosomal RNA (rRNA) or transfer RNA (tRNA), for example. The RNA may be a transcript. The RNA molecule may be (i) a clustered regularly interspaced short palindromic (CRISPR) RNA molecule (crRNA) or (ii) a single guide RNA (sgRNA) molecule. The RNA may be small RNA that are less than 200 nucleic acid bases in length, or large RNA that are greater than 200 nucleic acid bases in length. Small RNAs may include 5.8S ribosomal RNA (rRNA), 5S rRNA, transfer RNA (tRNA), microRNA (miRNA), small interfering RNA (siRNA), small nucleolar RNA (snoRNAs), Piwi-interacting RNA (piRNA), tRNA-derived small RNA (tsRNA) and small rDNA-derived RNA (srRNA). The RNA may be double-stranded RNA or single-stranded RNA. The RNA may be circular RNA. The macromolecular constituent may include a protein. The macromolecular constituent may include a peptide. The macromolecular constituent may include a polypeptide or a protein. The polypeptide or protein may be an extracellular or an intracellular polypeptide or protein. The macromolecular constituent may also include a metabolite. These and other suitable macromolecular constituents (also referred to as analytes) will be appreciated by those skilled in the art (see U.S. Pat. Nos. 10,011,872 and 10,323,278, and PCT Publication No. WO 2019/157529, each of which is incorporated herein by reference in its entirety).

The term “molecular tag,” as used herein, generally refers to a molecule capable of binding to a macromolecular constituent. The molecular tag may bind to the macromolecular constituent with high affinity. The molecular tag may bind to the macromolecular constituent with high specificity. The molecular tag may include a nucleotide sequence. The molecular tag may include an oligonucleotide or polypeptide sequence. The molecular tag may include a DNA aptamer. The molecular tag may be or include a primer. The molecular tag may be or include a protein. The molecular tag may include a polypeptide. The molecular tag may be a barcode.

The term “oil,” as used herein, generally refers to a liquid that is not miscible with water. An oil may have a density higher or lower than water and/or a viscosity higher or lower than water.

The term “sample,” as used herein, generally refers to a biological sample of a subject. The biological sample may be a nucleic acid sample or protein sample. The biological sample may be derived from another sample. The sample may be a tissue sample, such as a biopsy, core biopsy, needle aspirate, or fine needle aspirate. Tissue samples may originate from organs, including, but not limited to, eye, brain, lymph node, lung, heart, liver, kidney, stomach, intestine, colon, bladder. The sample may be fresh, frozen, fixed (e.g., with an aldehyde (e.g., formalin, paraformaldehyde, gluteraldehyde) or with an alcohol (e.g., methanol or ethanol), and/or paraffin-embedded. The sample may be a skin sample. The sample may be a cheek swab. The sample may include a biological particle, e.g., a cell or virus, or a population thereof, or it may alternatively be free of biological particles. A cell-free sample may include polynucleotides. Polynucleotides may be isolated from a bodily sample that may be selected from the group consisting of blood, plasma, serum, urine, saliva, mucosal excretions, sputum, stool and tears.

The term “sequencing,” as used herein, generally refers to methods and technologies for determining the sequence of nucleotide bases in one or more polynucleotides. The polynucleotides can be, for example, nucleic acid molecules such as deoxyribonucleic acid (DNA) or ribonucleic acid (RNA), including variants or derivatives thereof (e.g., single stranded DNA). Sequencing can be performed by various systems currently available, such as, without limitation, a sequencing system by ILLUMINA®, Pacific Biosciences (PACBIO®), Oxford NANOPORE®, or Life Technologies (ION TORRENT®). Alternatively or in addition, sequencing may be performed using nucleic acid amplification, polymerase chain reaction (PCR) (e.g., digital PCR, quantitative PCR, or real time PCR), or isothermal amplification. Such systems may provide a plurality of raw genetic data corresponding to the genetic information of a subject (e.g., human), as generated by the systems from a sample provided by the subject. In some examples, such systems provide sequencing reads (also “reads” herein). A read may include a string of nucleic acid bases corresponding to a sequence of a nucleic acid molecule that has been sequenced. In some situations, systems and methods provided herein may be used with proteomic information.

The term “subject,” as used herein, generally refers to an animal, such as a mammal (e.g., human) or avian (e.g., bird), or other organism, such as a plant. The subject can be a vertebrate, a mammal, a mouse, a primate, a simian or a human. Animals may include, but are not limited to, farm animals, sport animals, and pets. A subject can be a healthy or asymptomatic individual, an individual that has or is suspected of having a disease (e.g., cancer) or a pre-disposition to the disease, or an individual that is in need of therapy or suspected of needing therapy. A subject can be a patient.

### Devices

The devices (e.g., closed flow cells) described herein can be used to direct the flow of one or more liquids, e.g., direct the flow of one or more liquids to one or more regions of interest on a sample. The device includes a reaction chamber for holding a sample, which is in fluid communication with an inlet channel and a waste outlet. The inlet channel is flanked by two directing channels. The device is configured to allow liquids to flow from the inlet and directing channels through the reaction chamber (e.g., over the sample or portion thereof, including one or more regions of interest), and out via the waste outlet. In some instances, the inlet channel is in fluid communication with one or more reagent channels, each of which may be in fluid communication with a corresponding reagent reservoir. In some instances, the device is configured to allow liquids to flow from each of the reagent reservoirs and/or reagent channels to the reaction chamber, i.e., via the inlet channel. For example, different liquids may flow in sequence to a region of interest of the sample.

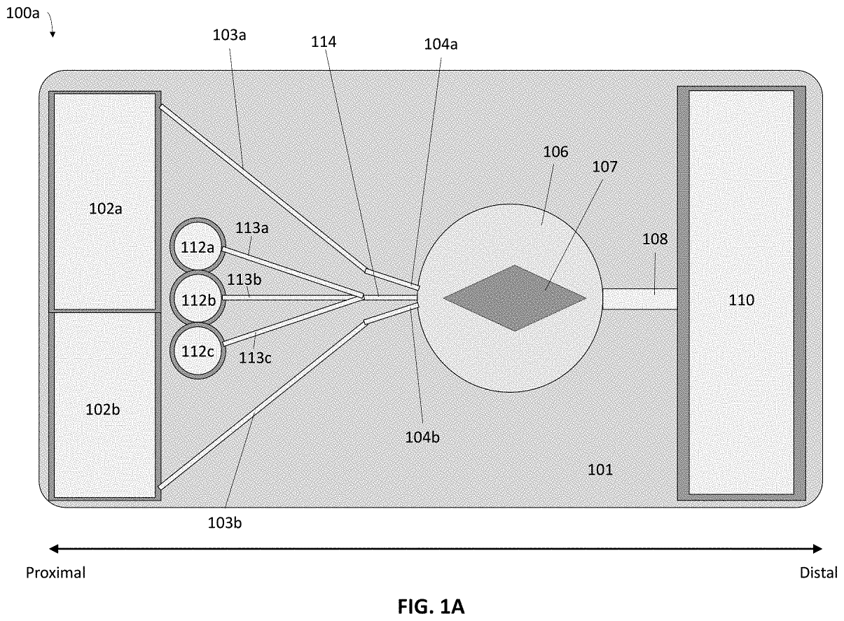

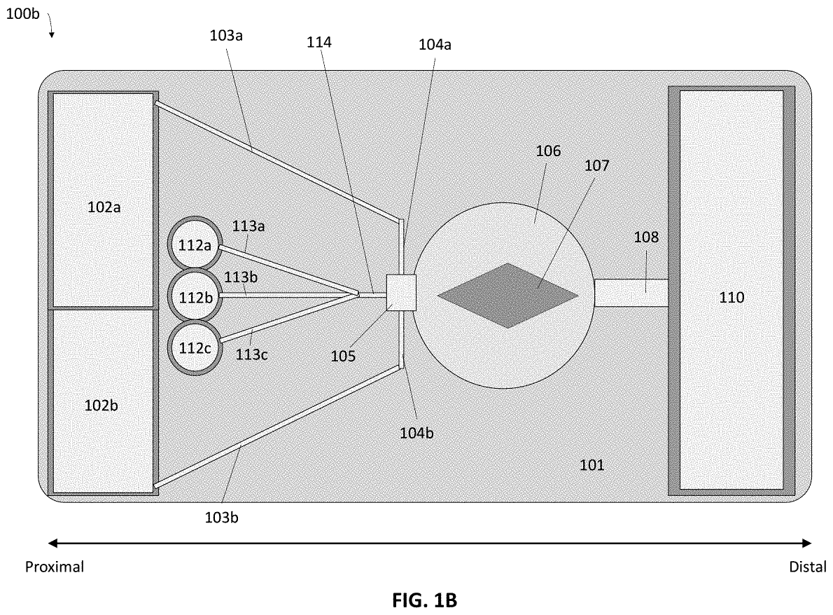

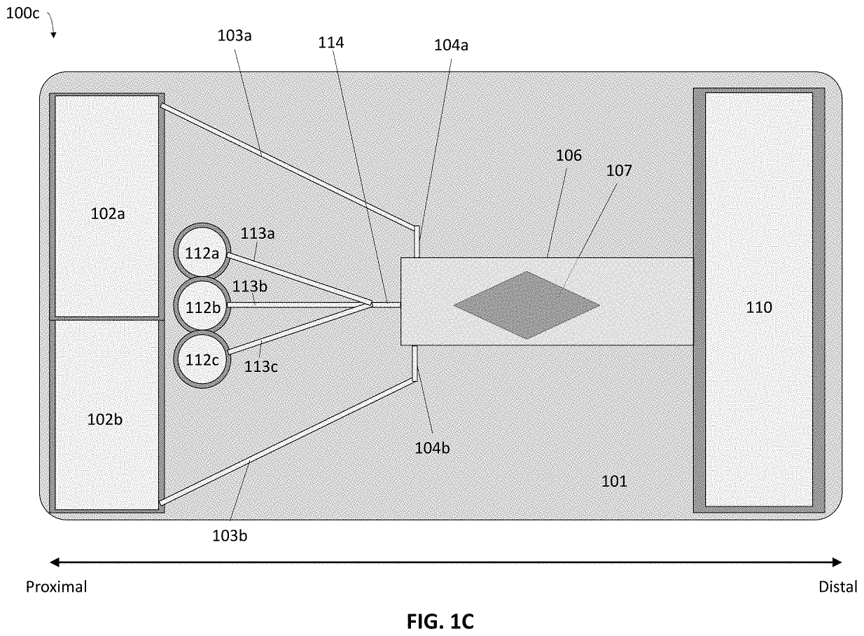

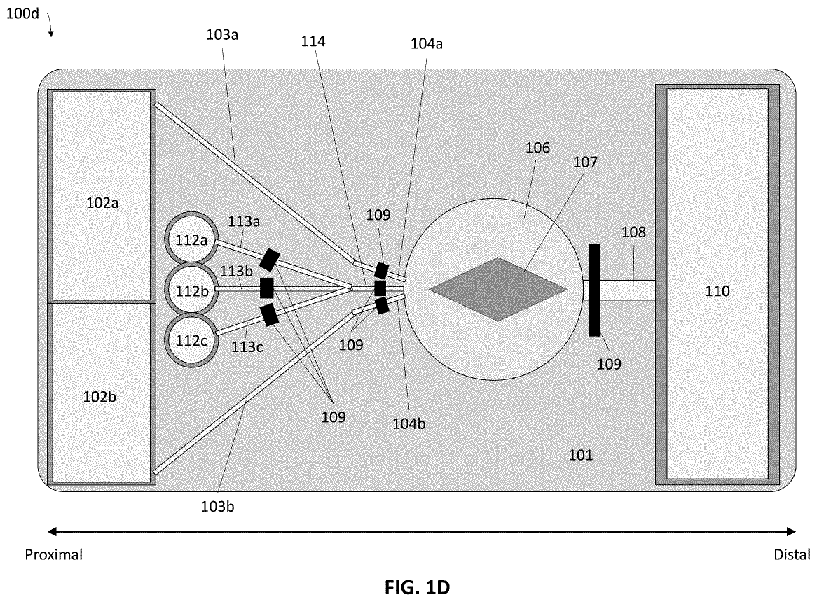

An exemplary device includes a first directing channel including a first directing proximal portion and a first directing distal portion; a second directing channel including a second directing proximal portion and a second directing distal portion; an inlet channel including an inlet proximal portion and an inlet distal portion; a reaction chamber; and a waste outlet. The inlet distal portion is disposed between the first directing distal portion and the second directing distal portion; the first directing distal portion, the second directing distal portion, and the inlet distal portion are in fluid communication with the reaction chamber; and the waste outlet is in fluid communication with the reaction chamber. Exemplary devices are shown in FIG. 1A-FIG. 1D.

In some instances, the first directing distal portion, the second directing distal portion, and the inlet distal portion are in fluid communication with the reaction chamber. The device may further include an inlet region. In some instances, two or more channels (reagent and directing channels) merge to the inlet region. The first directing distal portion, the second directing distal portion, and the inlet distal portion can be in fluid communication with the inlet region, and the inlet region can be in fluid communication with the reaction chamber. In some instances, two or more channels (reagent and directing channels) remain as separate channels with separate distal portions that are in fluid communication with the reaction chamber.

In various embodiments (e.g., with or without an inlet region), the first directing distal portion and the second directing distal portion have an angle relative to the inlet channel that is from about 0 degrees (i.e., parallel) to about 90 degrees (i.e., perpendicular), e.g., about 0, 1, 2, 3, 4, 5, 6, 7, 8, 9, 10, 15, 20, 25, 30, 40, 50, 60, 70, 80, or 90 degrees. In some embodiments, the first directing distal portion and the second directing distal portion have an angle relative to the inlet channel that is about 0 degrees (i.e., parallel).

In some embodiments, the device further includes at least one reagent channel in fluid communication with the inlet channel. In some embodiments, the at least one reagent channel includes a plurality of reagent channels. In some embodiments, the device further includes one or more (e.g., 1, 2, 3, 4, 5, 6, 7, 8, 9, 10, 11, 12, 13, 14, 15, 16, 17, 18, 19, 20, 25, 30, 35, 40, 45, 50, or more) additional reagent channels. In some embodiments, the device further includes at least one reagent reservoir in fluid communication with the at least one reagent channel. In some embodiments, the device further includes one or more (e.g., 1, 2, 3, 4, 5, 6, 7, 8, 9, 10, 11, 12, 13, 14, 15, 16, 17, 18, 19, 20, 25, 30, 35, 40, 45, 50, or more) additional reagent reservoirs. In some embodiments, the at least one reagent reservoir includes a plurality of reagent reservoirs, and each reagent reservoir of the plurality of reagent reservoirs is in fluid communication with a corresponding reagent channel of the plurality of reagent channels (e.g., a first reagent reservoir is in fluid communication with a first reagent channel, a second reagent reservoir is in fluid communication with a second reagent channel, a third reagent reservoir is in fluid communication with a third reagent channel, etc.; e.g., the n^{th} reagent reservoir is in fluid communication with the n^{th} reagent channel). In some embodiments, the device includes one or more reagent reservoirs integrated in the device. In some embodiments, the device includes one or more connections for fluid communication with the one or more reagent reservoirs.

In some embodiments, each reagent channel of the plurality of reagent channels is in fluid communication with the inlet channel.

In some embodiments, the first directing distal portion and the second directing distal portion are each disposed at a distance of about 100 μm to about 5 mm from the inlet channel (e.g., about 100 μm to about 5 mm; about 200 μm to about 5 mm; about 300 μm to about 5 mm; about 500 μm to about 5 mm; about 100 μm to about 4 mm; about 100 μm to about 3 mm; about 100 μm to about 2 mm; about 100 μm to about 1 mm; about 1 mm to about 5 mm; about 2 mm to about 5 mm; about 3 mm to about 5 mm; about 4 mm to about 5 mm; about 1 mm to about 4 mm; about 1 mm to about 3 mm; about 1 mm to about 2 mm; about 200 μm to about 2 mm; about 500 μm to about 3 mm; about 100 μm to about 500 μm; about 100 μm to about 300 μm; or about 100 μm to about 200 μm; e.g., about 100 μm; about 200 μm; about 300 μm; about 500 μm; about 750 μm; about 1 mm; about 2 mm; about 3 mm; about 4 mm; or about 5 mm).

In some embodiments, the first directing distal portion, the second directing distal portion, and the inlet distal portion are in fluid communication with a proximal side of the reaction chamber, and the waste outlet is in fluid communication with a distal side of the reaction chamber, e.g., where the distal side is opposite the proximal side.

In some embodiments, the device further includes at least one valve disposed along at least one of: the first directing distal portion, the second directing distal portion, and the inlet channel (and/or reagent channel(s) in fluid communication therewith). In some embodiments, the device further includes at least one valve disposed along the waste outlet. Suitable valves are known in the art and include mechanical, pneumatic, and magnetic valves.

In some instances, the device further includes one or more (e.g., 1, 2, 3, 4, 5, 6, 7, 8, 9, 10, 11, 12, 13, 14, 15, 16, 17, 18, 19, 20, 25, 30, 35, 40, 45, 50, or more) additional reagent channels. Each additional reagent channel may include a corresponding reagent proximal portion and a corresponding distal portion (e.g., a second reagent channel may include a second reagent proximal portion and a second reagent distal portion, a third reagent channel may include a third reagent proximal portion and a third reagent distal portion, etc.). Each additional reagent channel may be in fluid communication with the first reagent channel. Alternatively, an additional reagent channel may intersect the first reagent channel between the first reagent proximal portion and the first reagent distal portion, or an additional reagent channel may intersect another additional reagent channel. The device may further include a third reagent channel that intersects the first reagent channel between the first reagent proximal and distal portions or intersects the second reagent channel at a first reagent intersection. Each of the one or more reagent channels may be in fluid communication with the inlet channel. Each of the one or more reagent channels may be in fluid communication with the inlet region.

Devices may further include additional sets of directing, inlet, and reagent channels, e.g., to direct reagents to more than one region of interest, e.g., in the same or different samples, simultaneously.

An exemplary range of height for the reaction chamber, for any of the channels, or for the inlet region is between 10 μm and 3 mm, e.g., between 10 μm and 2.5 mm, 10 μm and 2 mm, 10 μm and 1 mm, 10 μm and 900 μm, 10 μm and 800 μm, 10 μm and 700 μm, 10 μm and 600 μm, 10 μm and 500 μm, 10 μm and 400 μm, 10 μm and 300 μm, 10 μm and 200 μm, 10 μm and 100 μm, 10 μm and 90 μm, 10 μm and 80 μm, 10 μm and 70 μm, 10 μm and 60 μm, 10 μm and 50 μm, 10 μm and 40 μm, 10 μm and 30 μm, 10 μm and 20 μm, 20 μm and 3 mm, 30 μm and 3 mm, 40 μm and 3 mm, 50 μm and 3 mm, 60 μm and 3 mm, 70 μm and 3 mm, 80 μm and 3 mm, 90 μm and 3 mm, 100 μm and 3 mm, 200 μm and 3 mm, 300 μm and 3 mm, 400 μm and 3 mm, 500 μm and 3 mm, 600 μm and 3 mm, 700 μm and 3 mm, 800 μm and 3 mm, 900 μm and 3 mm, 1 mm and 3 mm, 1.5 mm and 3 mm, 2 mm and 3 mm, 20 μm and 2.5 mm, 50 μm and 2 mm, 150 μm and 1.5 mm, 250 μm and 1 mm, or 400 μm and 1 mm.

An exemplary range of width for reaction chamber, for any of the channels, or for the inlet region is between 100 μm and 10 mm, e.g., between 100 μm and 2.5 mm, 100 μm and 2 mm, 100 μm and 1 mm, 100 μm and 900 μm, 100 μm and 800 μm, 100 μm and 700 μm, 100 μm and 600 μm, 100 μm and 500 μm, 100 μm and 400 μm, 100 μm and 300 μm, 100 μm and 200 μm, 100 μm and 100 μm, 150 μm and 190 μm, 130 μm and 180 μm, 500 μm and 750 μm, 500 μm and 600 μm, 400 μm and 750 μm, 200 μm and 400 μm, 300 μm and 900 μm, 1100 μm and 1250 μm, 500 μm and 2 mm, 300 μm and 1 mm, 1500 μm and 2 mm, 500 μm and 3 mm, 2600 μm and 3 mm, 1700 μm and 3 mm, 800 μm and 3 mm, 900 μm and 3 mm, 1100 μm and 3 mm, 1200 μm and 3 mm, 1300 μm and 3 mm, 1400 μm and 3 mm, 1600 μm and 3 mm, 1700 μm and 3 mm, 1800 μm and 3 mm, 1900 μm and 3 mm, 1 mm and 3 mm, 1.5 mm and 3 mm, 2 mm and 3 mm, 120 μm and 2.5 mm, 150 μm and 2 mm, 150 μm and 1.5 mm, 250 μm and 1 mm, 400 μm and 1 mm, 0.5 mm and 5 mm, 1.5 mm and 4 mm, 2.5 mm and 3 mm, 2.5 mm and 5 mm, 3 mm and 5 mm, 4 mm and 5 mm, 4 mm and 6 mm, 3 mm and 7 mm, 5.5 mm and 8 mm, 6 mm and 10 mm, 6 mm and 9 mm, 8 mm and 10 mm, or 9 mm and 10 mm.

The device may include or be in fluid communication with one or more reservoirs, e.g., reservoirs for directing fluids, reagents, and/or waste. In some instances, the device further includes a first directing reservoir in fluid communication with the first directing proximal portion, a second directing reservoir in fluid communication with the second directing proximal portion, and at least one additional reagent reservoir in fluid communication with the at least one additional reagent channel. Two or more directing channels may also be in fluid communication with a single reservoir. The device may further include a second reagent reservoir in fluid communication with the second reagent channel and/or a third reagent reservoir in fluid communication with the third reagent channel. The device may also include one or more additional reagent reservoirs in fluid communication with one or more reagent channels. Alternatively, the device may be configured to mate with sources of fluids, which may be external reservoirs such as vials, tubes, or pouches. Similarly, the device may be configured to mate with a separate component that houses the reservoirs. Reservoirs may be of any appropriate size, e.g., to hold 10 μL to 500 mL, e.g., 10 μL to 300 mL, 25 μL to 10 mL, 100 μL to 1 mL, 40 μL to 300 μL, 1 mL to 10 mL, or 10 mL to 100 mL. When multiple reservoirs are present, each reservoir may have the same or a different size.

The devices disclosed herein may include any suitable material, for example, polymeric materials, such as polyethylene or polyethylene derivatives, such as cyclic olefin copolymers (COC), polymethylmethacrylate (PMMA), polydimethylsiloxane (PDMS), polycarbonate, polystyrene, polypropylene, polyvinyl chloride, polytetrafluoroethylene, polyoxymethylene, polyether ether ketone, polycarbonate, polystyrene, or the like, or they may be fabricated in whole or in part from inorganic materials, such as silicon, or other silica based materials, e.g., glass, quartz, fused silica, borosilicate glass, metals, ceramics, and combinations thereof.

In some instances, the reaction chamber of the device includes a lid that is separable from the device. The lid may be glass, plastic, or any other suitable material. In some instances, the reaction chamber of the device includes a top portion and a bottom portion, wherein the top and bottom portion are sealable. A reaction chamber having a removable lid may be sealed through means known in the art, including through the use of a gasket, silicone, or a press fit molded plastic piece. A properly sealed reaction chamber will not leak fluid, particularly during use of the device. In some instances, the reaction chamber includes a sample. Suitable samples, including biological samples (e.g., tissue samples), are described in detail below.

In some instances, the reaction chamber includes a sample holder, e.g., including a sample. In some instances, the sample holder is separable from the device. In some instances, the lid includes the sample holder. The sample holder may be glass, plastic, or any other suitable material. For example, the sample holder may include or be configured to hold a coverslip or microscope slide. In some instances, the reaction chamber includes an area for positioning the sample holder, e.g., a recessed area. In some instances, the reaction chamber is designed to securely hold the sample holder and restrict movement of the sample holder.

In some instances, the reaction chamber of the device includes an optically transparent window. Alternatively, the lid of the reaction chamber may include the optically transparent window. In some instances, the optically transparent window may be made from suitable materials, including glass, quartz, polystyrene, polyethylene terephthalate, etc.

The devices described herein may further include one or more valves (e.g., disposed within any channel and/or any intersection between any two components of a device) to regulate the flow in any of the channels and/or regulate the flow of any liquid described herein between any two components of a device described herein.

The device may be a microfluidic device.

### Methods

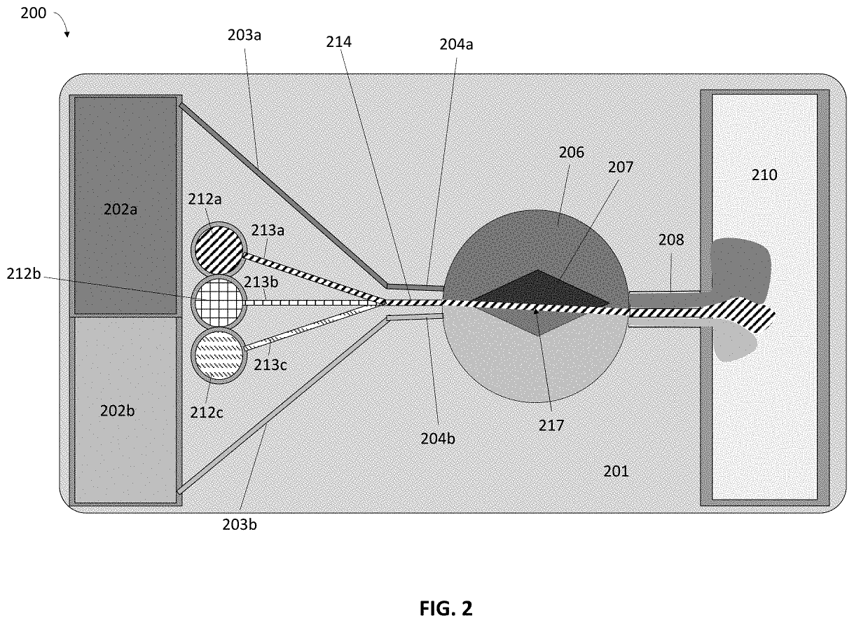

Methods disclosed herein may be used for directing the flow of one or more liquids (e.g., in a device, e.g., closed flow cell, described herein or in a reaction chamber described herein). In particular, the methods may be used to direct the flow of a first liquid (e.g., an aqueous liquid containing reagents) over a region of interest of a sample in the device to perform an analysis or assay, e.g., as described herein. The methods may involve flowing the first liquid (or multiple liquids containing reagents) through the inlet channel, and optionally from one or more reagent channels in fluid communication with the inlet channel channels, of the device into the reaction chamber while simultaneously flowing a second and a third liquid (e.g., an oil), e.g., that are immiscible with the first liquid, via the first and second directing channels. The first liquid (or other liquid), which is flanked by the second and third liquids, can be directed to a particular region of interest on the sample in the device by controlling the volumetric flow rates of the second and third liquids. Specifically, the flow of the first liquid (or the other liquid) will be directed away from the directing channel with the higher flow rate. See, e.g., FIG. 2.

An exemplary method includes: providing a device for directing the flow of one or more fluids described herein; flowing a first liquid from the inlet channel to the reaction chamber at a first flow rate, flowing a second liquid from the first directing channel to the reaction chamber at a second flow rate, and flowing a third liquid from the second directing channel to the reaction chamber at a third flow rate, wherein the first, second, and third flow rates direct the first liquid to a first region of interest in the sample, wherein the first region of interest is smaller than area of the sample.

In some embodiments, flow of the second and third liquids is initiated prior to flow of the first liquid, e.g., to allow for stabilization of the location of first region of interest prior to introduction of a reagent. Alternatively, flow of the first, second, and third liquids may be initiated substantially at the same time, and the first liquid does not include a reagent. Similar flow sequences may be used for other sets of liquids.

In some instances, the second and third flow rates determine the position of the first region of interest, e.g., where the first flow rate is constant over an assay. The second and third flow rates may be the same or different. For example, the second flow rate may be greater than the third flow rate by about 1%, 2%, 3%, 4%, 5%, 6%, 7%, 8%, 9%, 10%, 15%, 20%, 25%, 30%, 35%, 40%, 45%, 50%, 60%, 70%, 80%, 90%, 100%, 110%, 120%, 130%, 140%, 150%, 160%, 170%, 180%, 190%, 200%, 225%, 250%, 275%, 300%, 350%, 400%, 450%, 500%, 550%, 600%, 650%, 700%, 800%, 900%, 1000%, or more). Alternatively, the third flow rate may be greater than the second flow rate by about 1%, 2%, 3%, 4%, 5%, 6%, 7%, 8%, 9%, 10%, 15%, 20%, 25%, 30%, 35%, 40%, 45%, 50%, 60%, 70%, 80%, 90%, 100%, 110%, 120%, 130%, 140%, 150%, 160%, 170%, 180%, 190%, 200%, 225%, 250%, 275%, 300%, 350%, 400%, 450%, 500%, 550%, 600%, 650%, 700%, 800%, 900%, 1000%, or more). In some instances, the first liquid flows away from the directing channel having the higher flow rate.

Different liquids may be directed to the first region of interest in sequence. In some instances, the method further includes flowing one or more additional liquids from the inlet channel to the reaction chamber at the first flow rate, flowing the second liquid from the first directing channel to the reaction chamber at the second flow rate, and flowing the third liquid from the second directing channel to the reaction chamber at the third flow rate, wherein the first, second, and third flow rates direct the one or more additional liquids to the first region of interest.

In some instances, the method further includes flowing a fourth liquid from the inlet channel to the reaction chamber at the first flow rate, flowing the second liquid from the first directing channel to the reaction chamber at the second flow rate, and flowing the third liquid from the second directing channel to the reaction chamber at the third flow rate, wherein the first, second, and third flow rates direct the fourth liquid to the first region of interest.

The methods allow for the directing of fluids to multiple regions of interest, e.g., in sequence or parallel. In some methods, the first and fourth flow rates are different; the second and fifth flow rates are different; and/or the third and sixth flow rates are different. In some instances, only one, only two, or all 3 of the options above are true. In some instances, when at least one of the options above are true, the first and second regions of interest are different. The process may be repeated to direct fluids to any desired number of regions of interest.

In some instances, the fifth and sixth flow rates determine the position of the second region of interest, e.g., where the fourth flow rate is constant over an assay. In some instances, the fifth and third flow rates are the same. In some instances, the fifth and sixth flow rates are different. In some instances, the fifth flow rate is greater than the sixth flow rate by about 1%, 2%, 3%, 4%, 5%, 6%, 7%, 8%, 9%, 10%, 15%, 20%, 25%, 30%, 35%, 40%, 45%, 50%, 60%, 70%, 80%, 90%, 100%, 110%, 120%, 130%, 140%, 150%, 160%, 170%, 180%, 190%, 200%, 225%, 250%, 275%, 300%, 350%, 400%, 450%, 500%, 550%, 600%, 650%, 700%, 800%, 900%, 1000%, or more). In some instances, the sixth flow rate is greater than the fifth flow rate by about 1%, 2%, 3%, 4%, 5%, 6%, 7%, 8%, 9%, 10%, 15%, 20%, 25%, 30%, 35%, 40%, 45%, 50%, 60%, 70%, 80%, 90%, 100%, 110%, 120%, 130%, 140%, 150%, 160%, 170%, 180%, 190%, 200%, 225%, 250%, 275%, 300%, 350%, 400%, 450%, 500%, 550%, 600%, 650%, 700%, 800%, 900%, 1000%, or more). In some instances, the first liquid flows away from the directing channel (i.e., directing channel distal portion) having the higher flow rate.

The sample may be operatively positioned in the reaction chamber, wherein the one or more regions of interest may each include a fraction of the total sample area. In some instances, the first region of interest includes 1%, 2%, 3%, 4%, 5%, 6%, 7%, 8%, 9%, 10%, 15%, 20%, 25%, 30%, 35%, 40%, 45%, 50%, 60%, 70%, 80%, 90%, or 100% of the sample area. In some instances, the second region of interest includes 1%, 2%, 3%, 4%, 5%, 6%, 7%, 8%, 9%, 10%, 15%, 20%, 25%, 30%, 35%, 40%, 45%, 50%, 60%, 70%, 80%, 90%, or 100% of the sample area. The one or more regions of interest may be overlapping or non-overlapping. The sample may be a biological sample, e.g., a cell culture, or more preferably, a tissue sample. Samples suitable for use with the methods disclosed herein are described in detail below.

In some instances, the fluidic flow rates used in the methods described herein may be between about 0.01 μL/min to about 100 μL/min, e.g., 0.1 to 50 μL/min, 0.1 to 10 μL/min, or 1 to 5 μL/min. The flow rate of the first liquid may be between about 0.04 μL/min and about 40 μL/min or between about 0.01 μL/min and about 100 μL/min. Alternatively, the flow rate of the first liquid may be less than about 0.01 μL/min. Alternatively, the flow rate of the first liquid may be greater than about 40 μL/min, e.g., 45 μL/min, 50 μL/min, 55 μL/min, 60 μL/min, 65 μL/min, 70 μL/min, 75 μL/min, 80 μL/min, 85 μL/min, 90 μL/min, 95 μL/min, 100 μL/min, 110 μL/min, 120 μL/min, 130 μL/min, 140 μL/min, 150 μL/min, or greater. The flow rate may also be a lower flow rate, such as flow rates of about less than or equal to 10 μL/min.

In some instances, the method further includes taking one or more (e.g., 1, 2, 3, 4, 5, 6, 7, 8, 9, 10, 11, 12, 13, 14, 15, 16, 17, 18, 19, 20, 25, 30, 35, 40, 45, 50, or more) measurements (e.g., detections or observations) of the first region of interest. The measurements may be taken after one or more (e.g., 1, 2, 3, 4, 5, 6, 7, 8, 9, 10, 11, 12, 13, 14, 15, 16, 17, 18, 19, 20, 25, 30, 35, 40, 45, 50, or more) different liquids including reagents have been directed over the first region of interest. For example, the measurements may be taken at the first region of interest after the first liquid has been directed over the first region of interest.

The method may further include taking one or more (e.g., 1, 2, 3, 4, 5, 6, 7, 8, 9, 10, 11, 12, 13, 14, 15, 16, 17, 18, 19, 20, 25, 30, 35, 40, 45, 50, or more) measurements of the second region of interest. The measurements may be taken after one or more (e.g., 1, 2, 3, 4, 5, 6, 7, 8, 9, 10, 11, 12, 13, 14, 15, 16, 17, 18, 19, 20, 25, 30, 35, 40, 45, 50, or more) different liquids including reagents have been directed over the second region of interest. For example, the measurements may be taken at the second region of interest after the first liquid has been directed over the second region of interest.

In some instances, liquids containing reagents may be directed over all regions of interest prior to any measurements taking place. One or more (e.g., 1, 2, 3, 4, 5, 6, 7, 8, 9, 10, 11, 12, 13, 14, 15, 16, 17, 18, 19, 20, 25, 30, 35, 40, 45, 50, or more) measurements may be taken at all regions of interest.

Alternatively, one or more (e.g., 1, 2, 3, 4, 5, 6, 7, 8, 9, 10, 11, 12, 13, 14, 15, 16, 17, 18, 19, 20, 25, 30, 35, 40, 45, 50, or more) reference measurements may be taken prior to flowing of any liquids including reagents. For example, reference measurements may be taken at the first region of interest, at the second region of interest, or at any region of interest prior to flowing of any liquids including reagents.

Reagents for use with the methods described herein include, but are not limited to, reagents for detection of nucleic acids and proteins. Reagents may be suitable for use in an enzymatic reaction or a chemical reaction. Suitable reagents for use with the methods described herein include antibodies, buffers, enzymes, chelators, nucleotides, oligonucleotides, dyes, chemical crosslinkers, permeabilization reagents, clearing reagents, quenchers, and salts. Other reagents are described in detail below.

In some instances, the first liquid used in the methods disclosed herein is miscible with water, e.g., the first liquid is aqueous. In some instances, the second and third liquids used in the methods disclosed herein are not miscible with water and the first liquid is not miscible with the second liquid or the third liquid. The second and third liquids may be the same. In some instances, the second and third liquids are oils. In some instances, the fourth liquid used in the methods disclosed herein is miscible with water and with the first liquid. Liquids suitable for use with the methods are described in detail below.

Certain methods include heating or cooling the fluid. Heating or cooling of the fluid can be achieved by heating or cooling the fluid source or the fluid itself, for example by providing a heater or cooler, e.g., thermoelectric device, in operative contact with the reaction chamber, any one of the reagent channels, or any one of the reagent reservoirs. Heating and or cooling of the fluid may be used to perform temperature-dependent biochemical reactions in the tissue in the region of interest.

Certain methods include the additional step of obtaining data from a region of interest, e.g., by sequencing or optical detection of probes, e.g., using a microscope.

### Systems

Systems disclosed herein may be used for directing the flow of one or more liquids (e.g., in a device described herein or in a reaction chamber described herein). The systems may also be used with the methods described herein. An exemplary system includes a device for directing the flow of one or more liquids described herein; a controller capable of controlling the flow rate of liquids into the device; and (c) a computing device operatively linked to the device and the controller, and wherein the computing device is configured to control the flow rate of a first liquid in the inlet channel, the flow rate of a second liquid in the first directing channel, and the flow rate of a third liquid in second directing channel to direct the flow of the first liquid to a first region of interest in the reaction chamber, wherein the first region of interest is smaller than the area of the reaction chamber.

Device provided by the system may further include at least one (e.g., 1, 2, 3, 4, 5, 6, 7, 8, 9, 10, 11, 12, 13, 14, 15, 16, 17, 18, 19, 20, 25, 30, 35, 40, 45, 50, or more) reagent channels in fluid communication with the inlet channel. Each reagent channel may include a proximal portion and a distal portion. In some instances, the device further includes a second reagent channel that intersects the first reagent channel between the first reagent proximal portion and the first reagent distal portion and/or a third reagent channel that intersects the first reagent channel between the first reagent proximal and distal portions or intersects the second reagent channel at a first reagent intersection. Each of the at least one reagent channels may be in fluid communication with the inlet channel. Each of the at least one reagent channels may be in fluid communication with the inlet region.

In some cases, the device included in the system further includes a first directing reservoir in fluid communication with the first directing proximal portion, a second directing reservoir in fluid communication with the second directing proximal portion. The device may further include at least one reagent reservoir in fluid communication with any of the at least one reagent channels.

In some instances, the reaction chamber of the device included in the system includes a lid that is separable from the device. The reaction chamber may also include an optically transparent window.

The system further may further include a computing device including a user interface for selecting the first region of interest of a sample in the reaction chamber. For example, the user interface can be used to select one or more (e.g., 1, 2, 3, 4, 5, 6, 7, 8, 9, 10, 11, 12, 13, 14, 15, 16, 17, 18, 19, 20, or more) additional regions of interest in the reaction chamber.

In some instances, the system further includes the inlet channel including a first liquid; the first directing channel including a second liquid; and the second directing channel including a third liquid, and wherein the first liquid is immiscible with the second and third liquids.

In some instances, the sample in the reaction chamber further includes a second region of interest, and wherein the computing device is configured to control the flow rate of a first liquid in the inlet channel, the flow rate of a second liquid in the first directing channel, and the flow rate of a third liquid in second directing channel to direct the flow of the first liquid to a second region of interest in the reaction chamber, wherein the second region of interest is smaller than the area of the reaction chamber, and wherein the second region of interest is different from the first region of interest. The flow rates of the first and second directing channels may be different when directing flow of the first liquid to the first region of interest from when directing flow of the first liquid to the second region of interest. In some cases, the user interface can be used to select the second region of interest in the reaction chamber. In some instances, a sample may be washed prior to directing flow (e.g., of a reagent/first liquid) to a second region of interest.

In some instances, the controller is further capable of controlling the flow of liquid from each reagent channel. For example, each intersection of two reagent channels may include a fluidic switch, and in such cases, the controller may be capable of opening and closing each fluidic switch to control which reagent channels are fluidically connected to the reaction chamber. The devices described herein may include one or more valves to regulate the flow in any of the channels and/or regulate the flow of any liquid described herein between any two components of a device described herein. The controller may be further capable of controlling any of these valves. Computing devices, controllers, fluidic switches, and other components of the system may be operatively coupled to the device, e.g., by being integrated with, physically connected to (mechanically or electrically), or by wired or wireless connection.

In some cases, the systems described herein may include one or more liquid flow units to direct the flow of one or more liquids, e.g., a pump. Examples of pumps include syringe, peristaltic, diaphragm pumps, and sources of vacuum. Other pumps can employ centrifugal or electrokinetic forces. Alternatively, liquid movement may be controlled by gravity, capillarity, or surface treatments. Multiple pumps and mechanisms for liquid movement may be employed in a single device.

### Preparation of Samples

A variety of steps can be performed to prepare a biological tissue sample for analysis. In some embodiments, a sample is collected or deposited in the device described here and prepared using a device described herein. In some embodiments, a prepared sample is placed on a substrate layer described herein. Except where indicated otherwise, the preparative steps described below can generally be combined in any manner to appropriately prepare a particular sample for analysis. In some aspects, any of the preparative or processing steps described can be performed on a sample using a device described herein, e.g., to deliver reagents via a fluid source. For example, the preparing or processing may include but is not limited to steps for fixing, embedding, staining, crosslinking, permeabilizing the sample, or any combinations thereof.

A biological tissue sample can be harvested from a subject (e.g., via surgical biopsy, whole subject sectioning), grown in vitro on a growth substrate or culture dish as a population of cells, or prepared as a tissue slice or tissue section. Grown samples may be sufficiently thin for analysis without further processing steps. Alternatively, grown samples, and samples obtained via biopsy or sectioning, can be prepared as thin tissue sections using a mechanical cutting apparatus such as a vibrating blade microtome. As another alternative, in some embodiments, a thin tissue section can be prepared by applying a touch imprint of a biological sample to a suitable substrate material.

The thickness of the tissue section can be a fraction of (e.g., less than 0.9, 0.8, 0.7, 0.6, 0.5, 0.4, 0.3, 0.2, or 0.1) the maximum cross-sectional dimension of a cell. However, tissue sections having a thickness that is larger than the maximum cross-section cell dimension can also be used. For example, cryostat sections can be used, which can be, e.g., from about 10 μm to about 20 μm thick.

More generally, the thickness of a tissue section typically depends on the method used to prepare the section and the physical characteristics of the tissue, and therefore sections having a wide variety of different thicknesses can be prepared and used. For example, the thickness of the tissue section can be at least 0.1, 0.2, 0.3, 0.4, 0.5, 0.7, 1.0, 1.5, 2, 3, 4, 5, 6, 7, 8, 9, 10, 12, 13, 14, 15, 20, 30, 40, or 50 μm. Thicker sections can also be used if desired or convenient, e.g., at least 70, 80, 90, or 100 μm or more. Typically, the thickness of a tissue section is about 1-100 μm, 1-50 μm, 1-30 μm, 1-25 μm, 1-20 μm, 1-15 μm, 1-10 μm, 2-8 μm, 3-7 μm, or 4-6 μm, but as mentioned above, sections with thicknesses larger or smaller than these ranges can also be analyzed.

Multiple sections can also be obtained from a single biological sample. For example, multiple tissue sections can be obtained from a surgical biopsy sample by performing serial sectioning of the biopsy sample using a sectioning blade. Spatial information among the serial sections can be preserved in this manner, and the sections can be analyzed successively to obtain three-dimensional information about the biological sample.

In some embodiments, the biological tissue sample (e.g., a tissue section as described above) can be prepared by deep freezing at a temperature suitable to maintain or preserve the integrity (e.g., the physical characteristics) of the tissue structure. Such a temperature can be, e.g., less than −20° C., or less than −25° C., −30° C., −40° C., −50° C., −60° C., −70° C., 80° C.-90° C., −100° C., −110° C., −120° C., −130° C., −140° C., −150° C., −160° C., −170° C., −180° C., −190° C., or −200° C. The frozen tissue sample can be sectioned, e.g., thinly sliced, onto a substrate surface using any number of suitable methods. For example, a tissue sample can be prepared using a chilled microtome (e.g., a cryostat) set at a temperature suitable to maintain both the structural integrity of the tissue sample and the chemical properties of the nucleic acids in the sample. Such a temperature can be, e.g., less than −15° C., less than −20° C., or less than −25° C. A sample can be snap frozen in isopentane and liquid nitrogen. Frozen samples can be stored in a sealed container prior to embedding.

### Fixation and Postfixation

In some embodiments, the biological sample can be prepared using formalin-fixation and paraffin-embedding (FFPE), which are established methods. In some embodiments, cell suspensions and other non-tissue samples can be prepared using formalin-fixation and paraffin-embedding. Following fixation of the sample and embedding in a paraffin or resin block, the sample can be sectioned as described above. Prior to analysis, the paraffin-embedding material can be removed from the tissue section (e.g., deparaffinization) by incubating the tissue section in an appropriate solvent (e.g., xylene) followed by a rinse (e.g., 99.5% ethanol for 2 minutes, 96% ethanol for 2 minutes, and 70% ethanol for 2 minutes).

As an alternative to formalin fixation described above, a biological sample can be fixed in any of a variety of other fixatives to preserve the biological structure of the sample prior to analysis. For example, a sample can be fixed via immersion in ethanol, methanol, acetone, paraformaldehyde (PFA)-TRITON®, and combinations thereof.

In some embodiments, acetone fixation is used with fresh frozen samples, which can include, but are not limited to, cortex tissue, mouse olfactory bulb, human brain tumor, human post-mortem brain, and breast cancer samples. When acetone fixation is performed, pre-permeabilization steps (described below) may not be performed. Alternatively, acetone fixation can be performed in conjunction with permeabilization steps.

In some embodiments, the methods provided herein include one or more post-fixing (also referred to as postfixation) steps. In some embodiments, one or more post-fixing step is performed after contacting a sample with a polynucleotide disclosed herein, e.g., one or more probes such as a circular or padlock probe. In some embodiments, one or more post-fixing step is performed after a hybridization complex comprising a probe and a target is formed in a sample. In some embodiments, one or more post-fixing step is performed prior to a ligation reaction disclosed herein, such as the ligation to circularize a padlock probe.

In some embodiments, one or more post-fixing step is performed after contacting a sample with a binding or labelling agent (e.g., an antibody or antigen binding fragment thereof) for a non-nucleic acid analyte such as a protein analyte. The labelling agent can include a nucleic acid molecule (e.g., reporter oligonucleotide) comprising a sequence corresponding to the labelling agent and therefore corresponds to (e.g., uniquely identifies) the analyte. In some embodiments, the labelling agent can include a reporter oligonucleotide comprising one or more barcode sequences.

A post-fixing step may be performed using any suitable fixation reagent disclosed herein, for example, 3% (w/v) paraformaldehyde in DEPC-PBS.

### Embedding

As an alternative to paraffin embedding described above, a biological sample can be embedded in any of a variety of other embedding materials to provide structural substrate to the sample prior to sectioning and other handling steps. In some cases, the embedding material can be removed e.g., prior to analysis of tissue sections obtained from the sample. Suitable embedding materials include, but are not limited to, waxes, resins (e.g., methacrylate resins), epoxies, and agar.

In some embodiments, the biological sample can be embedded in a matrix (e.g., a hydrogel matrix). Embedding the sample in this manner typically involves contacting the biological sample with a hydrogel such that the biological sample becomes surrounded by the hydrogel. For example, the sample can be embedded by contacting the sample with a suitable polymer material, and activating the polymer material to form a hydrogel. In some embodiments, the hydrogel is formed such that the hydrogel is internalized within the biological sample.

In some embodiments, the biological sample is immobilized in the hydrogel via cross-linking of the polymer material that forms the hydrogel. Cross-linking can be performed chemically and/or photochemically, or alternatively by any other hydrogel-formation method known in the art.

The composition and application of the hydrogel-matrix to a biological sample typically depends on the nature and preparation of the biological sample (e.g., sectioned, non-sectioned, type of fixation). As one example, where the biological sample is a tissue section, the hydrogel-matrix can include a monomer solution and an ammonium persulfate (APS) initiator/tetramethylethylenediamine (TEMED) accelerator solution. As another example, where the biological sample consists of cells (e.g., cultured cells or cells disassociated from a tissue sample), the cells can be incubated with the monomer solution and APS/TEMED solutions. For cells, hydrogel-matrix gels are formed in compartments, including but not limited to devices used to culture, maintain, or transport the cells. For example, hydrogel-matrices can be formed with monomer solution plus APS/TEMED added to the compartment to a depth ranging from about 0.1 μm to about 2 mm.

Additional methods and aspects of hydrogel embedding of biological samples are described for example in Chen et al., Science 347(6221):543-548, 2015, the entire contents of which are incorporated herein by reference.

### Staining and Immunohistochemistry (IHC)

To facilitate visualization, biological samples can be stained using a wide variety of stains and staining techniques. In some embodiments, for example, a sample can be stained using any number of stains and/or immunohistochemical reagents. One or more staining steps may be performed to process a biological sample and may be performed during and/or after an assay (e.g., performed in the device provided herein). In some embodiments, the sample can be contacted with one or more nucleic acid stains, membrane stains (e.g., cellular or nuclear membrane), cytological stains, or combinations thereof. In some examples, the stain may be specific to proteins, phospholipids, DNA (e.g., dsDNA, ssDNA), RNA, an organelle or compartment of the cell. The sample may be contacted with one or more labeled antibodies (e.g., a primary antibody specific for the analyte of interest and a labeled secondary antibody specific for the primary antibody). In some embodiments, cells in the sample can be segmented using one or more images taken of the stained sample.

In some embodiments, the stain is performed using a lipophilic dye. In some examples, the staining is performed with a lipophilic carbocyanine or aminostyryl dye, or analogs thereof (e.g, DiI, DiO, DiR, DiD). Other cell membrane stains may include FM and RH dyes or immunohistochemical reagents specific for cell membrane proteins. In some examples, the stain may include but is not limited to, acridine orange, acid fuchsine, Bismarck brown, carmine, coomassie blue, cresyl violet, DAPI, eosin, ethidium bromide, acid fuchsine, haematoxylin, Hoechst stains, iodine, methyl green, methylene blue, neutral red, Nile blue, Nile red, osmium tetroxide, ruthenium red, propidium iodide, rhodamine (e.g., rhodamine B), or safranine, or derivatives thereof. In some embodiments, the sample may be stained with haematoxylin and eosin (H&E).

In some embodiments, biological samples can be destained. Methods of destaining or discoloring a biological sample are known in the art, and generally depend on the nature of the stain(s) applied to the sample. For example, in some embodiments, one or more immunofluorescent stains are applied to the sample via antibody coupling. Such stains can be removed using techniques such as cleavage of disulfide linkages via treatment with a reducing agent and detergent washing, chaotropic salt treatment, treatment with antigen retrieval solution, and treatment with an acidic glycine buffer. Methods for multiplexed staining and destaining are described, for example, in Bolognesi et al., J. Histochem. Cytochem. 2017; 65(8): 431-444, Lin et al., Nat Commun. 2015; 6:8390, Pirici et al., J. Histochem. Cytochem. 2009; 57:567-75, and Glass et al., J. Histochem. Cytochem. 2009; 57:899-905, the entire contents of each of which are incorporated herein by reference.

### Isometric Expansion

In some embodiments, a biological sample embedded in a matrix (e.g., a hydrogel) can be isometrically expanded. Isometric expansion methods that can be used include hydration, a preparative step in expansion microscopy, as described in Chen et al., Science 347(6221):543-548, 2015.

Isometric expansion can be performed by anchoring one or more components of a biological sample (e.g., nucleic acids, proteins) to a gel, followed by gel formation, proteolysis, and swelling. In some embodiments, analytes in the sample, products of the analytes, and/or probes associated with analytes in the sample can be anchored to the matrix (e.g., hydrogel). Isometric expansion of the biological sample can occur prior to immobilization of the biological sample on a substrate, or after the biological sample is immobilized to a substrate. In some embodiments, the isometrically expanded biological sample can be removed from the substrate prior to contacting the substrate with probes disclosed herein.

Isometric expansion of the sample can increase the spatial resolution of the subsequent analysis of the sample. The increased resolution in spatial profiling can be determined by comparison of an isometrically expanded sample with a sample that has not been isometrically expanded.

In some embodiments, a biological sample is isometrically expanded to a size at least 2×, 2.1×, 2.2×, 2.3×, 2.4×, 2.5×, 2.6×, 2.7×, 2.8×, 2.9×, 3×, 3.1×, 3.2×, 3.3×, 3.4×, 3.5×, 3.6×, 3.7×, 3.8×, 3.9×, 4×, 4.1×, 4.2×, 4.3×, 4.4×, 4.5×, 4.6×, 4.7×, 4.8×, or 4.9× its non-expanded size. In some embodiments, the sample is isometrically expanded to at least 2× and less than 20× of its non-expanded size.

### Crosslinking and De-Crosslinking

In some embodiments, the biological sample is reversibly cross-linked. In some aspects, the analytes, polynucleotides and/or product of an analyte or a probe bound thereto can be anchored to a polymer matrix. For example, the polymer matrix can be a hydrogel. In some embodiments, portions of the sample can be modified to contain functional groups that can be used as an anchoring site to attach to a polymer matrix. In some embodiments, a modified probe comprising oligo dT may be used to bind to mRNA molecules of interest, followed by reversible crosslinking of the mRNA molecules.

In some embodiments, a hydrogel can include hydrogel subunits, such as, but not limited to, acrylamide, bis-acrylamide, polyacrylamide and derivatives thereof, poly(ethylene glycol) and derivatives thereof (e.g. PEG-acrylate (PEG-DA), PEG-RGD), gelatin-methacryloyl (GeIMA), methacrylated hyaluronic acid (MeHA), polyaliphatic polyurethanes, polyether polyurethanes, polyester polyurethanes, polyethylene copolymers, polyamides, polyvinyl alcohols, polypropylene glycol, polytetramethylene oxide, polyvinyl pyrrolidone, polyacrylamide, poly(hydroxyethyl acrylate), and poly(hydroxyethyl methacrylate), collagen, hyaluronic acid, chitosan, dextran, agarose, gelatin, alginate, protein polymers, methylcellulose, and the like, and combinations thereof.

In some embodiments, a hydrogel includes a hybrid material, e.g., the hydrogel material includes elements of both synthetic and natural polymers. Examples of suitable hydrogels are described, for example, in U.S. Pat. Nos. 6,391,937, 9,512,422, and 9,889,422, and in U.S. Patent Application Publication Nos. 2017/0253918, 2018/0052081 and 2010/0055733, the entire contents of each of which are incorporated herein by reference.

In some embodiments, the hydrogel can form the substrate. In some embodiments, the substrate includes a hydrogel and one or more second materials. In some embodiments, the hydrogel is placed on top of one or more second materials. For example, the hydrogel can be pre-formed and then placed on top of, underneath, or in any other configuration with one or more second materials. In some embodiments, hydrogel formation occurs after contacting one or more second materials during formation of the substrate. Hydrogel formation can also occur within a structure (e.g., wells, ridges, projections, and/or markings) located on a substrate.

In some embodiments, hydrogel formation on a substrate occurs before, contemporaneously with, or after the sample is in the device. For example, hydrogel formation can be performed on the sample on the substrate layer.

In some embodiments, hydrogel formation occurs within a biological sample. In some embodiments, a biological sample (e.g., tissue section) is embedded in a hydrogel. In some embodiments, hydrogel subunits are infused into the biological sample, and polymerization of the hydrogel is initiated by an external or internal stimulus.

In embodiments in which a hydrogel is formed within a biological sample, functionalization chemistry can be used. In some embodiments, functionalization chemistry includes hydrogel-tissue chemistry (HTC). Any hydrogel-tissue backbone (e.g., synthetic or native) suitable for HTC can be used for anchoring biological macromolecules and modulating functionalization. Non-limiting examples of methods using HTC backbone variants include CLARITY, PACT, ExM, SWITCH and ePACT. In some embodiments, hydrogel formation within a biological sample is permanent. For example, biological macromolecules can permanently adhere to the hydrogel allowing multiple rounds of interrogation. In some embodiments, hydrogel formation within a biological sample is reversible.

In some embodiments, a method disclosed herein include de-crosslinking the reversibly cross-linked biological sample. The de-crosslinking does not need to be complete. In some embodiments, only a portion of crosslinked molecules in the reversibly cross-linked biological sample are de-crosslinked and allowed to migrate.

### Tissue Permeabilization and Treatment

In some embodiments, a biological sample can be permeabilized to facilitate transfer of analytes out of the sample, and/or to facilitate transfer of species (such as probes) into the sample. If a sample is not permeabilized sufficiently, the amount of analyte captured from the sample may be too low to enable adequate analysis. Conversely, if the tissue sample is too permeable, the relative spatial relationship of the analytes within the tissue sample can be lost. Hence, a balance between permeabilizing the tissue sample enough to obtain good signal intensity while still maintaining the spatial resolution of the analyte distribution in the sample is desirable.

In general, a biological sample can be permeabilized by exposing the sample to one or more permeabilizing agents. Suitable agents for this purpose include, but are not limited to, organic solvents (e.g., acetone, ethanol, and methanol), cross-linking agents (e.g., paraformaldehyde), detergents (e.g., saponin, TRITON® X-100 or TWEEN® 20), and enzymes (e.g., trypsin, proteases). In some embodiments, the biological sample can be incubated with a cellular permeabilizing agent to facilitate permeabilization of the sample. Additional methods for sample permeabilization are described, for example, in Jamur et al., Method Mol. Biol. 588:63-66, 2010, the entire contents of which are incorporated herein by reference. Any suitable method for sample permeabilization can generally be used in connection with the samples described herein.

In some embodiments, the biological sample can be permeabilized by adding one or more lysis reagents to the sample. Examples of suitable lysis agents include, but are not limited to, bioactive reagents such as lysis enzymes that are used for lysis of different cell types, e.g., gram positive or negative bacteria, plants, yeast, mammalian, such as lysozymes, achromopeptidase, lysostaphin, labiase, kitalase, lyticase, and a variety of other commercially available lysis enzymes.

Other lysis agents can additionally or alternatively be added to the biological sample to facilitate permeabilization. For example, surfactant-based lysis solutions can be used to lyse sample cells. Lysis solutions can include ionic surfactants such as, for example, sarcosyl and sodium dodecyl sulfate (SDS). More generally, chemical lysis agents can include, without limitation, organic solvents, chelating agents, detergents, surfactants, and chaotropic agents.

In some embodiments, the biological sample can be permeabilized by non-chemical permeabilization methods. Non-chemical permeabilization methods are known in the art. For example, non-chemical permeabilization methods that can be used include, but are not limited to, physical lysis techniques such as electroporation, mechanical permeabilization methods (e.g., bead beating using a homogenizer and grinding balls to mechanically disrupt sample tissue structures), acoustic permeabilization (e.g., sonication), and thermal lysis techniques such as heating to induce thermal permeabilization of the sample.

Additional reagents can be added to a biological sample to perform various functions prior to analysis of the sample. In some embodiments, DNase and RNase inactivating agents or inhibitors such as proteinase K, and/or chelating agents such as EDTA, can be added to the sample. For example, a method disclosed herein may include a step for increasing accessibility of a nucleic acid for binding, e.g., a denaturation step to opening up DNA in a cell for hybridization by a probe. For example, proteinase K treatment may be used to free up DNA with proteins bound thereto.

### Analytes

The methods and compositions disclosed herein can be used to detect and analyze a wide variety of different analytes. In some aspects, an analyte can include any biological substance, structure, moiety, or component to be analyzed. In some aspects, a target disclosed herein may similarly include any analyte of interest. In some examples, a target or analyte can be directly or indirectly detected.

Analytes can be derived from a specific type of cell and/or a specific sub-cellular region. For example, analytes can be derived from cytosol, from cell nuclei, from mitochondria, from microsomes, and more generally, from any other compartment, organelle, or portion of a cell. Permeabilizing agents that specifically target certain cell compartments and organelles can be used to selectively release analytes from cells for analysis, and/or allow access of one or more reagents (e.g., probes for analyte detection) to the analytes in the cell or cell compartment or organelle.

The analyte may include any biomolecule or chemical compound, including a macromolecule such as a protein or peptide, a lipid or a nucleic acid molecule, or a small molecule, including organic or inorganic molecules. The analyte may be a cell or a microorganism, including a virus, or a fragment or product thereof. An analyte can be any substance or entity for which a specific binding partner (e.g. an affinity binding partner) can be developed. Such a specific binding partner may be a nucleic acid probe (for a nucleic acid analyte) and may lead directly to the generation of a product. Alternatively, the specific binding partner may be coupled to a nucleic acid, which may be detected.

Analytes of particular interest may include nucleic acid molecules, such as DNA (e.g. genomic DNA, mitochondrial DNA, plastid DNA, viral DNA, etc.) and RNA (e.g. mRNA, microRNA, rRNA, snRNA, viral RNA, etc.), and synthetic and/or modified nucleic acid molecules, (e.g. including nucleic acid domains comprising or consisting of synthetic or modified nucleotides such as LNA, PNA, morpholino, etc.), proteinaceous molecules such as peptides, polypeptides, proteins or prions or any molecule which includes a protein or polypeptide component, etc., or fragments thereof, or a lipid or carbohydrate molecule, or any molecule which may include a lipid or carbohydrate component. The analyte may be a single molecule or a complex that contains two or more molecular subunits, e.g., including but not limited to protein-DNA complexes, which may or may not be covalently bound to one another, and which may be the same or different. Thus, in addition to cells or microorganisms, such a complex analyte may also be a protein complex or protein interaction. Such a complex or interaction may thus be a homo- or hetero-multimer. Aggregates of molecules, e.g., proteins may also be target analytes, for example aggregates of the same protein or different proteins. The analyte may also be a complex between proteins or peptides and nucleic acid molecules such as DNA or RNA, e.g., interactions between proteins and nucleic acids, e.g., regulatory factors, such as transcription factors, and DNA or RNA.

### Endogenous Analytes

In some embodiments, an analyte herein is endogenous to a biological sample and can include nucleic acid analytes and non-nucleic acid analytes. Methods and compositions disclosed herein can be used to analyze nucleic acid analytes (e.g., using a nucleic acid probe or probe set that directly or indirectly hybridizes to a nucleic acid analyte) and/or non-nucleic acid analytes (e.g., using a labelling agent that includes a reporter oligonucleotide and binds directly or indirectly to a non-nucleic acid analyte) in any suitable combination.

Examples of non-nucleic acid analytes include, but are not limited to, lipids, carbohydrates, peptides, proteins, glycoproteins (N-linked or O-linked), lipoproteins, phosphoproteins, specific phosphorylated or acetylated variants of proteins, amidation variants of proteins, hydroxylation variants of proteins, methylation variants of proteins, ubiquitylation variants of proteins, sulfation variants of proteins, viral coat proteins, extracellular and intracellular proteins, antibodies, and antigen binding fragments.

Examples of nucleic acid analytes include DNA analytes such as single-stranded DNA (ssDNA), double-stranded DNA (dsDNA), genomic DNA, methylated DNA, specific methylated DNA sequences, fragmented DNA, mitochondrial DNA, in situ synthesized PCR products, and RNA/DNA hybrids. The DNA analyte can be a transcript of another nucleic acid molecule (e.g., DNA or RNA such as mRNA) present in a tissue sample.

Examples of nucleic acid analytes also include RNA analytes such as various types of coding and non-coding RNA. Examples of the different types of RNA analytes include messenger RNA (mRNA), including a nascent RNA, a pre-mRNA, a primary-transcript RNA, and a processed RNA, such as a capped mRNA (e.g., with a 5′ 7-methyl guanosine cap), a polyadenylated mRNA (poly-A tail at the 3′ end), and a spliced mRNA in which one or more introns have been removed. Also included in the analytes disclosed herein are non-capped mRNA, a non-polyadenylated mRNA, and a non-spliced mRNA. The RNA analyte can be a transcript of another nucleic acid molecule (e.g., DNA or RNA such as viral RNA) present in a tissue sample. Examples of a non-coding RNAs (ncRNA) that is not translated into a protein include transfer RNAs (tRNAs) and ribosomal RNAs (rRNAs), as well as small non-coding RNAs such as microRNA (miRNA), small interfering RNA (siRNA), Piwi-interacting RNA (piRNA), small nucleolar RNA (snoRNA), small nuclear RNA (snRNA), extracellular RNA (exRNA), small Cajal body-specific RNAs (scaRNAs), and the long ncRNAs such as Xist and HOTAIR.

In some embodiments described herein, an analyte may be a denatured nucleic acid, wherein the resulting denatured nucleic acid is single-stranded. The nucleic acid may be denatured, for example, optionally using formamide, heat, or both formamide and heat. In some embodiments, the nucleic acid is not denatured for use in a method disclosed herein.

In certain embodiments, an analyte can be extracted from a live cell. Processing conditions can be adjusted to ensure that a biological sample remains live during analysis, and analytes are extracted from (or released from) live cells of the sample. Live cell-derived analytes can be obtained only once from the sample, or can be obtained at intervals from a sample that continues to remain in viable condition.

Methods and compositions disclosed herein can be used to analyze any number of analytes. For example, the number of analytes that are analyzed can be at least about 2, at least about 3, at least about 4, at least about 5, at least about 6, at least about 7, at least about 8, at least about 9, at least about 10, at least about 11, at least about 12, at least about 13, at least about 14, at least about 15, at least about 20, at least about 25, at least about 30, at least about 40, at least about 50, at least about 100, at least about 1,000, at least about 10,000, at least about 100,000 or more different analytes present in a region of the sample or within an individual feature of the substrate.

In any embodiment described herein, the analyte includes a target sequence. In some embodiments, the target sequence may be endogenous to the sample, generated in the sample, added to the sample, or associated with an analyte in the sample. In some embodiments, the target sequence is a single-stranded target sequence (e.g., a sequence in a rolling circle amplification product). In some embodiments, the analytes may include one or more single-stranded target sequences. In one aspect, a first single-stranded target sequence is not identical to a second single-stranded target sequence. In another aspect, a first single-stranded target sequence is identical to one or more second single-stranded target sequence. In some embodiments, the one or more second single-stranded target sequence is included in the same analyte (e.g., nucleic acid) as the first single-stranded target sequence. Alternatively, the one or more second single-stranded target sequence is included in a different analyte (e.g., nucleic acid) from the first single-stranded target sequence.

### Labelling Agents

In some embodiments, provided herein are methods and compositions for analyzing endogenous analytes (e.g., RNA, ssDNA, and cell surface or intracellular proteins and/or metabolites) in a sample using one or more labelling agents. In some embodiments, an analyte labelling agent may include an agent that interacts with an analyte (e.g., an endogenous analyte in a sample). In some embodiments, the labelling agents can include a reporter oligonucleotide that is indicative of the analyte or portion thereof interacting with the labelling agent. For example, the reporter oligonucleotide may include a barcode sequence that permits identification of the labelling agent. In some cases, the sample contacted by the labelling agent can be further contacted with a probe (e.g., a single-stranded probe sequence), that hybridizes to a reporter oligonucleotide of the labelling agent, in order to identify the analyte associated with the labelling agent. In some embodiments, the analyte labelling agent includes an analyte binding moiety and a labelling agent barcode domain comprising one or more barcode sequences, e.g., a barcode sequence that corresponds to the analyte binding moiety and/or the analyte. An analyte binding moiety barcode includes to a barcode that is associated with or otherwise identifies the analyte binding moiety. In some embodiments, by identifying an analyte binding moiety by identifying its associated analyte binding moiety barcode, the analyte to which the analyte binding moiety binds can also be identified. An analyte binding moiety barcode can be a nucleic acid sequence of a given length and/or sequence that is associated with the analyte binding moiety. An analyte binding moiety barcode can generally include any of the variety of aspects of barcodes described herein.

In some embodiments, the method may include one or more post-fixing (also referred to as post-fixation) steps after contacting the sample with one or more labelling agents.

In the methods and devices described herein, one or more labelling agents capable of binding to or otherwise coupling to one or more features may be used to characterize analytes, cells and/or cell features. In some instances, cell features include cell surface features. Analytes may include, but are not limited to, a protein, a receptor, an antigen, a surface protein, a transmembrane protein, a cluster of differentiation protein, a protein channel, a protein pump, a carrier protein, a phospholipid, a glycoprotein, a glycolipid, a cell-cell interaction protein complex, an antigen-presenting complex, a major histocompatibility complex, an engineered T-cell receptor, a T-cell receptor, a B-cell receptor, a chimeric antigen receptor, a gap junction, an adherens junction, or any combination thereof. In some instances, cell features may include intracellular analytes, such as proteins, protein modifications (e.g., phosphorylation status or other post-translational modifications), nuclear proteins, nuclear membrane proteins, or any combination thereof.

In some embodiments, an analyte binding moiety may include any molecule or moiety capable of binding to an analyte (e.g., a biological analyte, e.g., a macromolecular constituent). A labelling agent may include, but is not limited to, a protein, a peptide, an antibody (or an epitope binding fragment thereof), a lipophilic moiety (such as cholesterol), a cell surface receptor binding molecule, a receptor ligand, a small molecule, a bi-specific antibody, a bi-specific T-cell engager, a T-cell receptor engager, a B-cell receptor engager, a pro-body, an aptamer, a monobody, an affimer, a darpin, and a protein scaffold, or any combination thereof. The labelling agents can include (e.g., are attached to) a reporter oligonucleotide that is indicative of the cell surface feature to which the binding group binds. For example, the reporter oligonucleotide may include a barcode sequence that permits identification of the labelling agent. For example, a labelling agent that is specific to one type of cell feature (e.g., a first cell surface feature) may have coupled thereto a first reporter oligonucleotide, while a labelling agent that is specific to a different cell feature (e.g., a second cell surface feature) may have a different reporter oligonucleotide coupled thereto. For a description of exemplary labelling agents, reporter oligonucleotides, and methods of use, see, e.g., U.S. Pat. No. 10,550,429; U.S. Pat. Pub. 20190177800; and U.S. Pat. Pub. 20190367969, which are each incorporated by reference herein in their entirety.

In some embodiments, an analyte binding moiety includes one or more antibodies or antigen binding fragments thereof. The antibodies or antigen binding fragments including the analyte binding moiety can specifically bind to a target analyte. In some embodiments, the analyte is a protein (e.g., a protein on a surface of the biological sample (e.g., a cell) or an intracellular protein). In some embodiments, a plurality of analyte labelling agents comprising a plurality of analyte binding moieties bind a plurality of analytes present in a biological sample. In some embodiments, the plurality of analytes includes a single species of analyte (e.g., a single species of polypeptide). In some embodiments in which the plurality of analytes includes a single species of analyte, the analyte binding moieties of the plurality of analyte labelling agents are the same. In some embodiments in which the plurality of analytes includes a single species of analyte, the analyte binding moieties of the plurality of analyte labelling agents are the different (e.g., members of the plurality of analyte labelling agents can have two or more species of analyte binding moieties, wherein each of the two or more species of analyte binding moieties binds a single species of analyte, e.g., at different binding sites). In some embodiments, the plurality of analytes includes multiple different species of analyte (e.g., multiple different species of polypeptides).

In other instances, e.g., to facilitate sample multiplexing, a labelling agent that is specific to a particular cell feature may have a first plurality of the labelling agent (e.g., an antibody or lipophilic moiety) coupled to a first reporter oligonucleotide and a second plurality of the labelling agent coupled to a second reporter oligonucleotide.

In some aspects, these reporter oligonucleotides may include nucleic acid barcode sequences that permit identification of the labelling agent which the reporter oligonucleotide is coupled to. The selection of oligonucleotides as the reporter may provide advantages of being able to generate significant diversity in terms of sequence, while also being readily attachable to most biomolecules, e.g., antibodies, etc., as well as being readily detected, e.g., using sequencing or array technologies.

Attachment (coupling) of the reporter oligonucleotides to the labelling agents may be achieved through any of a variety of direct or indirect, covalent or non-covalent associations or attachments. For example, oligonucleotides may be covalently attached to a portion of a labelling agent (such a protein, e.g., an antibody or antibody fragment) using chemical conjugation techniques (e.g., Lightning-Link® antibody labelling kits available from Innova Biosciences), as well as other non-covalent attachment mechanisms, e.g., using biotinylated antibodies and oligonucleotides (or beads that include one or more biotinylated linker, coupled to oligonucleotides) with an avidin or streptavidin linker. Antibody and oligonucleotide biotinylation techniques are available. See, e.g., Fang, et al., “Fluoride-Cleavable Biotinylation Phosphoramidite for 5′-end-Labelling and Affinity Purification of Synthetic Oligonucleotides,” Nucleic Acids Res. Jan. 15, 2003; 31(2):708-715, which is entirely incorporated herein by reference for all purposes. Likewise, protein and peptide biotinylation techniques have been developed and are readily available. See, e.g., U.S. Pat. No. 6,265,552, which is entirely incorporated herein by reference for all purposes. Furthermore, click reaction chemistry may be used to couple reporter oligonucleotides to labelling agents. Commercially available kits, such as those from Thunderlink and Abcam, and techniques common in the art may be used to couple reporter oligonucleotides to labelling agents as appropriate. In another example, a labelling agent is indirectly (e.g., via hybridization) coupled to a reporter oligonucleotide comprising a barcode sequence that identifies the label agent. For instance, the labelling agent may be directly coupled (e.g., covalently bound) to a hybridization oligonucleotide that comprises a sequence that hybridizes with a sequence of the reporter oligonucleotide. Hybridization of the hybridization oligonucleotide to the reporter oligonucleotide couples the labelling agent to the reporter oligonucleotide. In some embodiments, the reporter oligonucleotides are releasable from the labelling agent, such as upon application of a stimulus. For example, the reporter oligonucleotide may be attached to the labeling agent through a labile bond (e.g., chemically labile, photolabile, thermally labile, etc.) as generally described for releasing molecules from supports elsewhere herein. In some instances, the reporter oligonucleotides described herein may include one or more functional sequences that can be used in subsequent processing, such as an adapter sequence, a unique molecular identifier (UMI) sequence, a sequencer specific flow cell attachment sequence (such as an P5, P7, or partial P5 or P7 sequence), a primer or primer binding sequence, a sequencing primer or primer biding sequence (such as an R1, R2, or partial R1 or R2 sequence).

In some cases, the labelling agent can comprise a reporter oligonucleotide and a label. A label can be fluorophore, a radioisotope, a molecule capable of a colorimetric reaction, a magnetic particle, or any other suitable molecule or compound capable of detection. The label can be conjugated to a labelling agent (or reporter oligonucleotide) either directly or indirectly (e.g., the label can be conjugated to a molecule that can bind to the labelling agent or reporter oligonucleotide). In some cases, a label is conjugated to a first oligonucleotide that is complementary (e.g., hybridizes) to a sequence of the reporter oligonucleotide.

In some embodiments, multiple different species of analytes (e.g., polypeptides) from the biological sample can be subsequently associated with the one or more physical properties of the biological sample. For example, the multiple different species of analytes can be associated with locations of the analytes in the biological sample. Such information (e.g., proteomic information when the analyte binding moiety(ies) recognizes a polypeptide(s)) can be used in association with other spatial information (e.g., genetic information from the biological sample, such as DNA sequence information, transcriptome information (i.e., sequences of transcripts), or both). For example, a cell surface protein of a cell can be associated with one or more physical properties of the cell (e.g., a shape, size, activity, or a type of the cell). The one or more physical properties can be characterized by imaging the cell. The cell can be bound by an analyte labelling agent comprising an analyte binding moiety that binds to the cell surface protein and an analyte binding moiety barcode that identifies that analyte binding moiety. Results of protein analysis in a sample (e.g., a tissue sample or a cell) can be associated with DNA and/or RNA analysis in the sample.

Products of Endogenous Analyte and/or Labelling Agent

In some embodiments, provided herein are methods and compositions for analyzing one or more products of an endogenous analyte and/or a labelling agent in a biological sample. In some embodiments, an endogenous analyte (e.g., a viral or cellular DNA or RNA) or a product (e.g., a hybridization product, a ligation product, an extension product (e.g., by a DNA or RNA polymerase), a replication product, a transcription/reverse transcription product, and/or an amplification product. In some aspects, the generation and/or processing of the analytes may be performed in the device described herein and/or the analysis of the analytes may be performed in the device described herein, such as by delivering reagents to a sample via a fluid source (e.g., via the one or more reagent channels). For example, the generation, processing, and analysis may include but is not limited to reactions including hybridizations, ligations, binding, extension, amplifications, or other enzymatic reactions. In some embodiments, a labelling agent that directly or indirectly binds to an analyte in the biological sample is analyzed. In some embodiments, a product (e.g., a hybridization product, a ligation product, an extension product (e.g., by a DNA or RNA polymerase), a replication product, a transcription/reverse transcription product, and/or an amplification product of a labelling agent that directly or indirectly binds to an analyte in the biological sample is analyzed.

### Hybridization

In some embodiments, a product of an endogenous analyte and/or a labelling agent is a hybridization product comprising the pairing of substantially complementary or complementary nucleic acid sequences within two different molecules, one of which is the endogenous analyte or the labelling agent (e.g., reporter oligonucleotide attached thereto). The other molecule can be another endogenous molecule or another labelling agent such as a probe. Pairing can be achieved by any process in which a nucleic acid sequence joins with a substantially or fully complementary sequence through base pairing to form a hybridization complex. For purposes of hybridization, two nucleic acid sequences are “substantially complementary” if at least 60% (e.g., at least 70%, at least 80%, or at least 90%) of their individual bases are complementary to one another.

Various probes and probe sets can be hybridized to an endogenous analyte and/or a labelling agent and each probe may comprise one or more barcode sequences. Exemplary barcoded probes or probe sets may be based on a padlock probe, a gapped padlock probe, a SNAIL (Splint Nucleotide Assisted Intramolecular Ligation) probe set, a PLAYR (Proximity Ligation Assay for RNA) probe set, a PLISH (Proximity Ligation in situ Hybridization) probe set, and RNA-templated ligation probes. The specific probe or probe set design can vary.

### Ligation

In some embodiments, a product of an endogenous analyte and/or a labelling agent is a ligation product. In some embodiments, the ligation product is formed between two or more endogenous analytes. In some embodiments, the ligation product is formed between an endogenous analyte and a labelling agent. In some embodiments, the ligation product is formed between two or more labelling agent. In some embodiments, the ligation product is an intramolecular ligation of an endogenous analyte. In some embodiments, the ligation product is an intramolecular ligation of a labelling agent, for example, the circularization of a circularizable probe or probe set upon hybridization to a target sequence. The target sequence can be comprised in an endogenous analyte (e.g., nucleic acid such as a genomic DNA or mRNA) or a product thereof (e.g., cDNA from a cellular mRNA transcript), or in a labelling agent (e.g., the reporter oligonucleotide) or a product thereof.

In some embodiments, the ligation involves chemical ligation. In some embodiments, the ligation involves template dependent ligation. In some embodiments, the ligation involves template independent ligation. In some embodiments, the ligation involves enzymatic ligation.

In some embodiments, the enzymatic ligation involves use of a ligase. In some aspects, the ligase used herein comprises an enzyme that is commonly used to join polynucleotides together or to join the ends of a single polynucleotide. An RNA ligase, a DNA ligase, or another variety of ligase can be used to ligate two nucleotide sequences together. Ligases comprise ATP-dependent double-strand polynucleotide ligases, NAD-i-dependent double-strand DNA or RNA ligases and single-strand polynucleotide ligases, for example any of the ligases described in EC 6.5.1.1 (ATP-dependent ligases), EC 6.5.1.2 (NAD₊-dependent ligases), EC 6.5.1.3 (RNA ligases). Specific examples of ligases comprise bacterial ligases such as E. coli DNA ligase, Tth DNA ligase, Thermococcus sp. (strain 9° N) DNA ligase (9°N™ DNA ligase, New England Biolabs), Taq DNA ligase, Ampligase™ (Epicentre Biotechnologies) and phage ligases such as T3 DNA ligase, T4 DNA ligase and T7 DNA ligase and mutants thereof. In some embodiments, the ligase is a T4 RNA ligase. In some embodiments, the ligase is a splintR ligase. In some embodiments, the ligase is a single stranded DNA ligase. In some embodiments, the ligase is a T4 DNA ligase. In some embodiments, the ligase is a ligase that has an DNA-splinted DNA ligase activity. In some embodiments, the ligase is a ligase that has an RNA-splinted DNA ligase activity.

In some embodiments, the ligation herein is a direct ligation. In some embodiments, the ligation herein is an indirect ligation. “Direct ligation” means that the ends of the polynucleotides hybridize immediately adjacently to one another to form a substrate for a ligase enzyme resulting in their ligation to each other (intramolecular ligation). Alternatively, “indirect” means that the ends of the polynucleotides hybridize non-adjacently to one another, i.e., separated by one or more intervening nucleotides or “gaps”. In some embodiments, said ends are not ligated directly to each other, but instead occurs either via the intermediacy of one or more intervening (so-called “gap” or “gap-filling” (oligo)nucleotides) or by the extension of the 3′ end of a probe to “fill” the “gap” corresponding to said intervening nucleotides (intermolecular ligation). In some cases, the gap of one or more nucleotides between the hybridized ends of the polynucleotides may be “filled” by one or more “gap” (oligo)nucleotide(s) which are complementary to a splint, padlock probe, or target nucleic acid. The gap may be a gap of 1 to 60 nucleotides or a gap of 1 to 40 nucleotides or a gap of 3 to 40 nucleotides. In specific embodiments, the gap may be a gap of about 1, 2, 3, 4, 5, 6, 7, 8, 9, or 10 or more nucleotides, of any integer (or range of integers) of nucleotides in between the indicated values. In some embodiments, the gap between said terminal regions may be filled by a gap oligonucleotide or by extending the 3′ end of a polynucleotide. In some cases, ligation involves ligating the ends of the probe to at least one gap (oligo)nucleotide, such that the gap (oligo)nucleotide becomes incorporated into the resulting polynucleotide. In some embodiments, the ligation herein is preceded by gap filling. In other embodiments, the ligation herein does not require gap filling.

In some embodiments, ligation of the polynucleotides produces polynucleotides with melting temperature higher than that of unligated polynucleotides. Thus, in some aspects, ligation stabilizes the hybridization complex containing the ligated polynucleotides prior to subsequent steps, comprising amplification and detection.

In some aspects, a high fidelity ligase, such as a thermostable DNA ligase (e.g., a Taq DNA ligase), is used. Thermostable DNA ligases are active at elevated temperatures, allowing further discrimination by incubating the ligation at a temperature near the melting temperature (Tₘ) of the DNA strands. This selectively reduces the concentration of annealed mismatched substrates (expected to have a slightly lower Tₘ around the mismatch) over annealed fully base-paired substrates. Thus, high-fidelity ligation can be achieved through a combination of the intrinsic selectivity of the ligase active site and balanced conditions to reduce the incidence of annealed mismatched dsDNA.

In some embodiments, the ligation herein is a proximity ligation of ligating two (or more) nucleic acid sequences that are in proximity with each other, e.g., through enzymatic means (e.g., a ligase). In some embodiments, proximity ligation can include a “gap-filling” step that involves incorporation of one or more nucleic acids by a polymerase, based on the nucleic acid sequence of a template nucleic acid molecule, spanning a distance between the two nucleic acid molecules of interest (see, e.g., U.S. Pat. No. 7,264,929, the entire contents of which are incorporated herein by reference). A wide variety of different methods can be used for proximity ligating nucleic acid molecules, including (but not limited to) “sticky-end” and “blunt-end” ligations. Additionally, single-stranded ligation can be used to perform proximity ligation on a single-stranded nucleic acid molecule. Sticky-end proximity ligations involve the hybridization of complementary single-stranded sequences between the two nucleic acid molecules to be joined, prior to the ligation event itself. Blunt-end proximity ligations generally do not include hybridization of complementary regions from each nucleic acid molecule because both nucleic acid molecules lack a single-stranded overhang at the site of ligation.

### Primer Extension and Amplification

In some embodiments, a product is a primer extension product of an analyte, a labelling agent, a probe or probe set bound to the analyte (e.g., a padlock probe bound to genomic DNA, mRNA, or cDNA), or a probe or probe set bound to the labelling agent (e.g., a padlock probe bound to one or more reporter oligonucleotides from the same or different labelling agents).

A primer is generally a single-stranded nucleic acid sequence having a 3′ end that can be used as a substrate for a nucleic acid polymerase in a nucleic acid extension reaction. RNA primers are formed of RNA nucleotides, and are used in RNA synthesis, while DNA primers are formed of DNA nucleotides and used in DNA synthesis. Primers can also include both RNA nucleotides and DNA nucleotides (e.g., in a random or designed pattern). Primers can also include other natural or synthetic nucleotides described herein that can have additional functionality. In some examples, DNA primers can be used to prime RNA synthesis and vice versa (e.g., RNA primers can be used to prime DNA synthesis). Primers can vary in length. For example, primers can be about 6 bases to about 120 bases. For example, primers can include up to about 25 bases. A primer, may in some cases, refer to a primer binding sequence. A primer extension reaction generally refers to any method where two nucleic acid sequences become linked (e.g., hybridized) by an overlap of their respective terminal complementary nucleic acid sequences (i.e., for example, 3′ termini). Such linking can be followed by nucleic acid extension (e.g., an enzymatic extension) of one, or both termini using the other nucleic acid sequence as a template for extension. Enzymatic extension can be performed by an enzyme including, but not limited to, a polymerase and/or a reverse transcriptase.

In some embodiments, a product of an endogenous analyte and/or a labelling agent is an amplification product of one or more polynucleotides, for instance, a circular probe or circularizable probe or probe set. In some embodiments, the amplifying is achieved by performing rolling circle amplification (RCA). In other embodiments, a primer that hybridizes to the circular probe or circularized probe is added and used as such for amplification. In some embodiments, the RCA comprises a linear RCA, a branched RCA, a dendritic RCA, or any combination thereof.

In some embodiments, the amplification is performed at a temperature between or between about 20° C. and about 60° C. In some embodiments, the amplification is performed at a temperature between or between about 30° C. and about 40° C. In some aspects, the amplification step, such as the rolling circle amplification (RCA) is performed at a temperature between at or about 25° C. and at or about 50° C., such as at or about 25° C., 27° C., 29° C., 31° C., 33° C., 35° C., 37° C., 39° C., 41° C., 43° C., 45° C., 47° C., or 49° C.

In some embodiments, upon addition of a DNA polymerase in the presence of appropriate dNTP precursors and other cofactors, a primer is elongated to produce multiple copies of the circular template. This amplification step can utilize isothermal amplification or non-isothermal amplification.

### Target Sequences

A target sequence for a probe disclosed herein may be comprised in any analyte disclose herein, including an endogenous analyte (e.g., a viral or cellular nucleic acid), a labelling agent, or a product of an endogenous analyte and/or a labelling agent.

In some aspects, one or more of the target sequences includes one or more barcode(s), e.g., at least two, three, four, five, six, seven, eight, nine, ten, or more barcodes. Barcodes can spatially-resolve molecular components found in biological samples, for example, within a cell or a tissue sample. A barcode can be attached to an analyte or to another moiety or structure in a reversible or irreversible manner. A barcode can be added to, for example, a fragment of a deoxyribonucleic acid (DNA) or ribonucleic acid (RNA) sample before or during sequencing of the sample. Barcodes can allow for identification and/or quantification of individual sequencing-reads (e.g., a barcode can be or can include a unique molecular identifier or “UMI”). In some aspects, a barcode comprises about 4, 5, 6, 7, 8, 9, 10, 11, 12, 13, 14, 15, 16, 17, 18, 19, 20, 21, 22, 23, 24, 25, 26, 27, 28, 29, 30, or more than 30 nucleotides.

In some embodiments, a barcode includes two or more sub-barcodes that together function as a single barcode. For example, a polynucleotide barcode can include two or more polynucleotide sequences (e.g., sub-barcodes) that are separated by one or more non-barcode sequences. In some embodiments, the one or more barcode(s) can also provide a platform for targeting functionalities, such as oligonucleotides, oligonucleotide-antibody conjugates, oligonucleotide-streptavidin conjugates, modified oligonucleotides, affinity purification, detectable moieties, enzymes, enzymes for detection assays or other functionalities, and/or for detection and identification of the polynucleotide.

In some embodiments, in a barcode sequencing method, barcode sequences are detected for identification of other molecules including nucleic acid molecules (DNA or RNA) longer than the barcode sequences themselves, as opposed to direct sequencing of the longer nucleic acid molecules. In some embodiments, a N-mer barcode sequence comprises 4^{N} complexity given a sequencing read of N bases, and a much shorter sequencing read may be required for molecular identification compared to non-barcode sequencing methods such as direct sequencing. For example, 1024 molecular species may be identified using a 5-nucleotide barcode sequence (4⁵=1024), whereas 8 nucleotide barcodes can be used to identify up to 65,536 molecular species, a number greater than the total number of distinct genes in the human genome. In some embodiments, the barcode sequences contained in the probes or rolling circle amplification products (RCPs) are detected, rather than endogenous sequences, which can be an efficient read-out in terms of information per cycle of sequencing. Because the barcode sequences are pre-determined, they can also be designed to feature error detection and correction mechanisms, see, e.g., U.S. Pat. Pub. 20190055594 and WO2019199579A1, which are hereby incorporated by reference in their entirety.

### Assays

The methods described herein may be useful for analysis methods in which specific reagents are added to a sample. In some embodiments, reagents are added to the sample in the device which include but are not limited to oligonucleotides (e.g., probes, dNTPs, primers), enzymes (e.g., endonucleases to fragment DNA, DNA polymerase enzymes, RNA polymerase, transposase, ligase, proteinase K, reverse transcriptase enzymes, including enzymes with terminal transferase activity, and DNAse), buffers and washes. In some embodiments, optical labels or dyes are added to the sample. In some embodiments, a sample can be collected from the device after performing steps of the assay described herein. In some embodiments, the device is used to perform or prepare sample for in situ analysis methods which include, e.g., in situ hybridization and in situ sequencing. In situ hybridization is a hybridization process in which labeled nucleic acids that are complementary to a specific nucleic acid (e.g., DNA or RNA) sequence in a biological sample hybridize to a portion or section of the sample (e.g., tissue) in which the nucleic acid is present.

The labeled nucleic acids, also referred to as probes, are generally short oligonucleotides in which at least a portion of the oligonucleotide is a reverse complement to a target nucleic acid of interest. The probes may include additional components in addition to the hybridization portion. For example, the probes may include additional sequences (e.g., barcode sequences), that are unique labels or identifiers to convey information about the nucleic acid being detected. The probes may further include a label attached thereto, directly or indirectly. The label may be, e.g., an optical label, a molecular label (e.g., an antigen), a radiolabel, or a field attractable label (e.g., electric or magnetic). In some embodiments the optical label is a fluorescent label, e.g., as used in fluorescence in situ hybridization (FISH). A fluorescent label can be detected by routine optical detection methods known in the art.

Optical detection may be performed by any detector capable of measuring light (e.g., the emitted, scattered, or attenuated light) from the label. Suitable detectors include, but are not limited to, a spectrometer, a light meter, a photometer, a photodiode, a photomultiplier tube, a CCD array, a CMOS sensor, or a photovoltaic device.

In situ methods may first include fixing and/or permeabilizing a biological sample (e.g., tissue). The biological sample may be provided in the device, e.g., on a substrate layer. The sample may be permeabilized by adding a fluid, such as a solvent (e.g., acetone and methanol) or a detergent (e.g., TRITON® X-100, NP-40, TWEEN® 20, saponin, digitonin, and Leucoperm), to the sample. Permeabilization may allow or enhance access of the probes for the intracellular space of the sample.

In some embodiments, a plurality of probes is used, e.g., for ease of detection and/or signal amplification, such as any probes described herein. For example, a first probe may include a nucleic acid sequence that hybridizes to a target nucleic acid in the sample. A secondary probe that includes a label (e.g., optical label, e.g., fluorescent label) may then be added that hybridizes to the first probe. In some embodiments, a plurality of secondary or higher order (e.g., tertiary, quaternary) detection probes are added. Each probe may be provided by a separate fluid source. Each probe may be provided by a single fluid source that includes a plurality of distinct probes.

When a probe that includes a detection label is added, the unbound probes with detection labels can be washed away and the signal can be detected, e.g., via fluorescence microscopy.

In some embodiments, the signal or template target nucleic acid is amplified. In some embodiments, an analyte (e.g., target nucleic acid) can be amplified using an enzyme, e.g., by polymerase chain reaction (PCR) or rolling circle amplification (RCA). The target nucleic acid may be replicated, e.g., by using the probe as a primer to initiate DNA or RNA synthesis. In such an embodiment, one or more fluids are added (e.g., sequentially) to the sample to provide the reagents for nucleic acid synthesis. Suitable reagents include, but are not limited to, probes, primers, nucleotide triphosphates (NTPs, e.g., dNTPs), sequencing terminators, dyes, polymerases, ligases, transcriptases (e.g., reverse transcriptases), labels, and the like.

In some embodiments, the methods described herein includes in situ sequencing or sequence detection. One such process includes temporal multiplexing of barcoded probes. In some embodiments, a primary probe or set of primary probes hybridize to a target nucleic acid (e.g., mRNA) in the sample. Each probe may contain a barcode attached thereto. The barcodes may then be detected by contacting with one or more probes each labeled with a fluorescent label which emits a signal. Each round of barcoding may be initiated by flowing the desired probe from a new fluid source. The labels may be detected using different excitation wavelengths (e.g., 640 nm, 561 nm, or 488 nm) during different barcoding rounds. By compiling the spatiotemporal patterns of each fluorescent signal at a location, the unique set of ordered barcode sequences that corresponds to a particular gene can be determined. Such a method may allow multiplex sequencing of a large number of (e.g., of 100, 1,000, 10,000, or more) nucleic acids, e.g., up to 90,000 transcripts per cell. This method also allows for efficient quantification of low-copy number nucleic acids.

In some embodiments, the in situ detection and/or in situ sequencing is performed in three dimensions. In this embodiment, the biological sample may be sequence by using a probe that includes a unique gene identifier. The probe may be ligated, thereby allowing extension and amplification of the target sequence. In some embodiments the amplification product can then be modified with a chemical moiety that polymerizes in the presence of a polymerization initiator. In some embodiments, an amplified product may be embedded within a polymerized matrix (e.g., a hydrogel), thereby creating spatially fixed three-dimensional target analytes of the biological sample.

In some embodiments, the in situ sequencing includes sequencing by ligation. In this embodiment, fluorescently labeled probes with two known bases followed by degenerate or universal bases hybridize to a temple. A ligase immobilizes the complex and the biological sample is imaged to detect the label on the probe. Following detection, the fluorophore is cleaved from the probe along with several bases, revealing a free 5′ phosphate. This process of hybridization, ligation, imaging, and cleavage can be repeating in multiple rounds, thereby allowing identification of, e.g., 2 out of every 5 bases. After a round of probe extension, all probes and anchors are removed and the cycle can begin again with an offset anchor, thus allowing sequencing of a new register of the target.

In another embodiment, sequencing by ligation includes labeled probes with a known base (e.g., A, C, T, or G) flanked on each side of the known base by degenerate or universal bases that hybridize to a template (e.g., three or four bases on each side). Each probe contains a different fluorescent label corresponding to each individual base. Each round of sequencing includes hybridizing a probe with a known base, ligation of the probe, detection, and optionally, cleavage of the fluorescent label. Sequencing can be performed in a plus or minus direction, and rounds of sequencing can begin again with an offset anchor, thus allowing sequencing of a new register of the target.

Detection of analytes in a sample in situ can provide spatial information of biological and/or medical importance. For example, the methods and compositions described herein can allow for: identification of one or more biomarkers (e.g., diagnostic, prognostic, and/or for determination of efficacy of a treatment) of a disease or disorder; identification of a candidate drug target for treatment of a disease or disorder; identification (e.g., diagnosis) of a subject as having a disease or disorder; identification of stage and/or prognosis of a disease or disorder in a subject; identification of a subject as having an increased likelihood of developing a disease or disorder; monitoring of progression of a disease or disorder in a subject; determination of efficacy of a treatment of a disease or disorder in a subject; identification of a patient subpopulation for which a treatment is effective for a disease or disorder; modification of a treatment of a subject with a disease or disorder; selection of a subject for participation in a clinical trial; and/or selection of a treatment for a subject with a disease or disorder.

In some instances, the methods and compositions described herein can allow for: identification of transcriptome and/or proteome expression profiles (e.g., in healthy and/or diseased tissue); identification of multiple analyte types in close proximity (e.g., nearest neighbor analysis); determination of up- and/or down-regulated genes and/or proteins in diseased tissue; characterization of tumor microenvironments; characterization of tumor immune responses; characterization of cells types and their co-localization in tissue; and identification of genetic variants within tissues (e.g., based on gene and/or protein expression profiles associated with specific disease or disorder biomarkers).

### Liquids

Liquids disclosed herein may be miscible with water or immiscible with water (e.g., an oil). Liquids miscible with water may be aqueous. Liquids immiscible with water may be non-aqueous. The liquids may contain chemicals for preservation of the biological tissue sample. Examples of aqueous liquid media include, e.g., sterile water and phosphate buffered saline. Examples of oils include mineral oil and silicone oils. In some instances, the first liquid and fourth liquids are miscible with water and the second and third liquids are immiscible with water. In some instances, the first liquid, the fourth liquid, and other liquids miscible with the first and fourth liquids may contain reagents described herein.

In some instances, the second and third liquids do not substantially mix with the first liquid, the fourth liquid, or any other liquids that includes the reagents described herein. In some instances, the second and third liquids may be an oil. In some instances, the second and third liquids may include agents that increase viscosity or crowding agents (e.g., polymers such as polyethylene glycol (PEG), glycerol, or dextran (e.g., dextran sulfate)). In some embodiments, the second and third liquids may be used to block the first and/or fourth liquids from contacting sample at regions outside of a region of interest (e.g., the first or second region of interest). The directing liquids and the reagent liquid may also be miscible, e.g., where minimal mixing occurs by diffusion during traverse of the reaction chamber.

### Heating and Cooling

Devices may include a heater and/or cooler, e.g., in thermal contact with a fluid source or in thermal contact with the sample. Suitable heaters include, but are not limited to, thermoelectric heaters, e.g., thermistors, resistive foil, metal ceramic heaters, thermal tape, a Peltier stage, a TEC controller, etc. Exemplary coolers include high thermal mass or high surface area heat sinks, heat exchangers, Peltier stages, flowing water, a chiller pump, etc.

Heaters and coolers may be configured to supply fluid at appropriate temperatures to perform certain biochemical reactions, e.g., initialization, ligation, DNA melting, annealing, extension, denaturation, etc.

It will be understood that any of the heating sources and temperatures described herein may also be used together. For example, a Peltier stage may be used to heat the source of fluid, while a resistive foil or metal ceramic heater maintains the fluid temperature.

### Reagents

The fluid sources described herein may contain one or more reagents that are delivered to a sample at a region of interest. A fluid source may include one or more (e.g., 2, 3, 4, 5, 6, 7, 8, 9, 10, or more) reagents, or each reagent may be contained in a distinct reagent reservoir.

In some instances, the first liquid includes a reagent for detecting a nucleic acid in the sample (e.g., including for any of the generation, processing, and analysis methods and reactions described herein). In some instances, the reagent is for a nucleic acid sequencing reaction. In some instances, the reagent is for a DNA sequencing reaction or an RNA sequencing reaction. In some instances, the reagent is for in situ hybridization (ISH). In some instances, the reagent is for fluorescence in situ hybridization (FISH).

In some instances, the first liquid includes a reagent for detecting a protein in the sample. In some instances, the reagent is for immunohistochemistry (IHC).

In some instances, the first liquid includes a reagent for an enzymatic reaction.

In some instances, the first liquid includes a reagent for a chemical reaction.

In some instances, reagents are selected from antibodies, buffers, enzymes, chelators, nucleotides, oligonucleotides, dyes, chemical crosslinkers, permeabilization reagents, clearing reagents, quenchers, and salts. In some instances, enzymes are selected from polymerases, ligases, nuclease inhibitors, and proteases. In some instances, oligonucleotides include primers and/or nucleic acid probes. In some instances, the nucleic acid probes are detectably labeled.

Other reagents that may be provided by a fluid source include, without limitation, a tissue fixing agent, a tissue permeabilizer, such as a solvent (e.g., acetone and methanol) or a detergent (e.g., TRITON® X-100, NP-40, TWEEN® 20, saponin, digitonin, and Leucoperm).

### Kits

Devices disclosed herein may be combined with various external components, e.g., heaters, coolers, detectors, pumps, reservoirs, or controllers, one or more detectors (e.g., one or more lenses (e.g., tube lens), microscope objectives, lasers, spectrometers, etc.), liquid handlers, reagents (e.g., detectable labels, nucleic acids, oligonucleotides, ligands, enzymes, detergents, proteins, fluorochromes, metal ions, etc., e.g., analyte detection moieties, liquids, and/or sample holders), instrumentation, computing devices (e.g., computer) in the form of kits.

### EXAMPLES

The following examples are included for illustrative purposes only and are not intended to limit the scope of the present disclosure.

### Example 1: Device for Delivering Reagents for Performing an In Situ Assay on Regions of Interest in a Sample

This example describes the design and use of an exemplary device for directing liquid flow within a device that includes a reaction chamber (flow area) which holds a tissue sample.

FIG. 1A-FIG. 1D are schematics of exemplary devices 100a, 100b, 100c, and 100d (e.g., closed flow cells) for directing reagent flow to a specific region of interest of a sample disposed within the device.

FIG. 1A shows a schematic of an exemplary device 100a (e.g., a closed flow cell). The device 100a includes a substrate 101. In various embodiments, the substrate 101 is glass. In various embodiments, the substrate 101 is a polymer (e.g., polydimethylsiloxane, etc.). The device 100a includes a first reservoir 102a and a second reservoir 102b. In various embodiments, the first reservoir 102a and the second reservoir 102b may contain an oil. In various embodiments, the first reservoir 102a contains a first oil, and the second reservoir 102b contains a second oil. In various embodiments, the first oil and the second oil are the same. In various embodiments, the first oil and the second oil have different properties (e.g., viscosity, density, etc.). The first reservoir 102a is in fluid communication with a first directing channel having a first directing proximal portion 103a and a first directing distal portion 104a. The second reservoir 102b is in fluid communication with a second directing channel having a second directing proximal portion 103b and a second directing distal portion 104b. The device 100a further includes one or more reagent reservoirs, for example, a first reagent reservoir 112a, a second reagent reservoir 112b, and a third reagent reservoir 112c. The first reagent reservoir 112a is in fluid communication with a first reagent channel 113a, the second reagent reservoir 112b is in fluid communication with a second reagent channel 113b, and the third reagent reservoir 112c is in fluid communication with a third reagent channel 113c. The reagent channels 113a-113c are in fluid communication with an inlet channel 114, which is in fluid communication with the reaction chamber 106 (e.g., into which a sample 107 may be placed). In the exemplary device 100a, the second reagent channel 113b and third reagent channel 113c both intersect the first reagent channel 113a. As shown in FIG. 1A, the inlet channel 114 is disposed between the first directing distal portion 104a and the second directing distal portion 104b. The distal portions of the channels are closer to the reaction chamber than the proximal portions. The reaction chamber 106 is in fluid communication with a waste outlet 108 and a waste reservoir 110. In various embodiments, the reaction chamber 106 has a circular cross-section (e.g., is cylindrical in volume). In various embodiments, the reaction chamber 106 has a rectangular cross-section. In various embodiments, the reaction chamber 106 has a square cross section. This example describes a method for nucleic acid detection (e.g., RNA, DNA, cDNA, or a generated product, such as an amplification product) using detectably labeled probes and various reagents delivered to the sample using the device.

In various embodiments, a distance between the first directing distal portion 104a and the inlet channel 114, and/or a distance between the second directing distal portion 104b and the inlet channel 114 is about 100 μm to about 10 mm. In various embodiments, a distance between the first directing distal portion 104a and the inlet channel 114, and/or a distance between the second directing distal portion 104b and the inlet channel 114 is about 100 μm to about 5 mm. In various embodiments, a distance between the first directing distal portion 104a and the inlet channel 114, and/or a distance between the second directing distal portion 104b and the inlet channel 114 is about 100 μm to about 4 mm. In various embodiments, a distance between the first directing distal portion 104a and the inlet channel 114, and/or a distance between the second directing distal portion 104b and the inlet channel 114 is about 100 μm to about 3 mm. In various embodiments, a distance between the first directing distal portion 104a and the inlet channel 114, and/or a distance between the second directing distal portion 104b and the inlet channel 114 is about 100 μm to about 2 mm. In various embodiments, a distance between the first directing distal portion 104a and the inlet channel 114, and/or a distance between the second directing distal portion 104b and the inlet channel 114 is about 100 μm to about 1 mm.

A cryosectioned tissue sample adhered to a substrate is fixed and permeabilized and optionally washed. After fixation and permeabilization, the sample is placed in the reaction chamber, and the reaction chamber is sealed for fluid delivery. Various probes and/or enzymes (e.g., each from a separate reagent reservoir via a corresponding reagent channel) are delivered to a specified region of interest within the reaction chamber (flow area) sequentially and each incubated with the sample. Each reagent can be removed from the sample, or washes can be performed, and liquid is moved to the waste outlet. The tissue in the device is contacted with probes (e.g., detectably labeled probes) and imaged to detect the probes in the specified region of the sample.

FIG. 1B is a schematic of an exemplary device 100b (e.g., closed flow cell) for directing reagent flow to a specific region of interest of a sample disposed within the device. The device 100b of FIG. 1B is substantially similar to the device 100a illustrated in FIG. 1A. As shown in FIG. 1B, the device 100b further includes an inlet region 105 with which the first directing distal portion 104a, the inlet channel 114, and the second directing distal portion 104b are in fluid communication. In various embodiments, the first directing distal portion 104a and the second directing distal portion 104b have an angle relative to the inlet channel that is from about 0 degrees (i.e., parallel) to about 90 degrees (i.e., perpendicular). In some embodiments, the first directing distal portion 104a and the second directing distal portion 104b have an angle relative to the inlet channel that is about 0 degrees (i.e., parallel).

FIG. 1C is a schematic of an exemplary device 100c (e.g., closed flow cell) for directing reagent flow to a specific region of interest of a sample disposed within the device. The device 100b of FIG. 1C is substantially similar to the device 100a illustrated in FIG. 1A and FIG. 1B. As shown in FIG. 1C, the device 100c includes a reaction chamber 106 that has a rectangular cross-section. The reaction chamber 106 is in fluid communication with the first directing distal portion 104a, the second directing distal portion 104b, the inlet channel 114, and the waste reservoir 110 without any other channels therebetween.

FIG. 1D is a schematic of an exemplary device 100d (e.g., closed flow cell) with valves 109 for directing reagent flow to a specific region of interest of a sample disposed within the device. The device 100d of FIG. 1D is substantially similar to the device 100a illustrated in FIG. 1A. As shown in FIG. 1D, the device 100d includes one or more valves 109 to restrict fluid flow through one or more of the channels. For example, one or more valves 109 may be positioned along any one (e.g., all) of the reagent channels 113a-113c. In another example, one or more valves 109 may be positioned along any one (e.g., all) of the first directing distal portion 104a, the second directing distal portion 104b, and/or the inlet channel 114. In another example, one or more valves 109 may be positioned along the waste channel 108. In various embodiments, one or more valves 109 may be positioned along the first directing proximal portion 103a and/or the second directing proximal portion 103b (not shown). In various embodiments, when actuated, each valve 109 restricts (e.g., prevents) fluid flow therethrough.

FIG. 2 is a schematic demonstrating an exemplary method of directing liquid flow within a device 200. The device 200 is substantially similar to the device 100a of FIG. 1A and includes a substrate 201. The device 200 includes a first reservoir 202a having a first oil and a second reservoir 202b having a second oil. The first reservoir 202a is in fluid communication with a first directing channel having a first directing proximal portion 203a and a first directing distal portion 204a. The second reservoir 202b is in fluid communication with a second directing channel having a second directing proximal portion 203b and a second directing distal portion 204b. The device 200 further includes one or more reagent reservoirs, for example, a first reagent reservoir 212a having a first reagent, a second reagent reservoir 212b having a second reagent, and a third reagent reservoir 212c having a third reagent. In various embodiments, each reagent reservoir includes one or more reagents corresponding to a different panel (e.g., RNA panel, protein panel, gene panel, etc.). The first reagent reservoir 212a is in fluid communication with a first reagent channel 213a, the second reagent reservoir 212b is in fluid communication with a second reagent channel 213b, and the third reagent reservoir 212c is in fluid communication with a third reagent channel 213c. The reagent channels 213a-213c are in fluid communication with an inlet channel 214, which is in fluid communication with the reaction chamber 206 (e.g., into which a sample 207 may be placed). In the exemplary device 200a, the second reagent channel 213b and third reagent channel 213c both intersect the first reagent channel 213a. The reaction chamber 206 is in fluid communication with a waste outlet 208 and a waste reservoir 210.

As shown in FIG. 2, an aqueous liquid (e.g., first reagent from the first reagent reservoir 212a) flows through the corresponding reagent channel 213a and the inlet channel 214, a first oil flows from the oil reservoir 202a and through the first directing channel, and a second oil flows from the oil reservoir 202b and through the second directing channel, all into the reaction chamber 206 and over a sample 207 positioned within the reaction chamber 206. The first oil and the second oil have volumetric flow rates q1 and q2, respectively. In the example illustrated in FIG. 2, q1 is higher than q2, and thus the flow of the aqueous liquid from the reagent reservoir 212a is directed downwards across the lower portion of the tissue sample 207, across the region of interest 217.

For example, the first reagent reservoir 212a may include a first sequencing probe, the second reagent reservoir 212b may include a second sequencing probe, and the third reagent reservoir 212c may include a third sequencing probe. By sequentially flowing the three sequencing probes over the region of interest 217 of the sample 207, e.g., by maintaining the same ratio of q1/q2 during the flow from all three reagents, the same region of interest can be analyzed by three successive probes. In various embodiments, the ratio of q1/q2 is changed for each reagent reservoir 212a-212c such that each reagent flows over a different region of interest on the sample 207. In various embodiments, the reaction chamber includes a plurality of samples (e.g., arranged in a series along a reaction chamber). In various embodiments, the selected reagent flows over a region of interest on each of the plurality of samples.

In various embodiments, the sample thickness is about 10 μm. In various embodiments, the sample thickness is about 1 μm to about 20 μm. In various embodiments, the sample thickness is about 5 μm to about 15 μm. In various embodiments, the sample thickness is about 10 μm to about 20 μm. In various embodiments, the sample thickness is about 10 μm to about 30 μm. In various embodiments, the sample thickness is about 10 μm to about 40 μm. In various embodiments, the sample thickness is about 10 μm to about 50 μm. In various embodiments, the sample thickness is about 10 μm to about 60 μm. In various embodiments, the sample thickness is about 10 μm to about 70 μm. In various embodiments, the sample thickness is about 10 μm to about 80 μm. In various embodiments, the sample thickness is about 10 μm to about 90 μm. In various embodiments, the sample thickness is about 10 μm to about 100 μm.

Various ratios of flow rates can be determined depending on the region of interest 217 of the sample 207 selected by the user. For example, to deliver reagent to the middle portion of the reaction chamber 206, a flow ratio of q1=q2 can be used. In some cases, to target a region of interest of the sample 207 in the left portion (i.e., closer to the first directing channel than the second directing channel) of the reaction chamber 206, a flow ratio of q1/q2<1 can be used. In some cases, to target a region of interest of the sample 207 in the right portion (i.e., closer to the second directing channel than the first directing channel) of the reaction chamber 206, a flow ratio of q1/q2=1.5 may be used. In another example, to target a region of interest 217 of the sample even further in the right portion of the reaction chamber 206, a flow ratio of q1/q2=2 can be used. A controller and computing device coupled to the device can be used to control the flow rate of reagents in the one or more reagent channels (e.g., 213a-213c), the flow rate of an oil in the first directing channel, and the flow rate of an oil in second directing channel to direct the flow of the reagent to a specified region of interest 217 in the reaction chamber 206 selected by the user. One or more rounds of reagent delivery (e.g., of additional reagents) and detection can be performed on the same region of interest 217 in the sample 207 or a different region of interest in the sample 207 by directing fluid flow as described. In various embodiments, a wash can be performed (e.g., to remove oil or other liquid from the directing channels) prior to delivery of reagents to a second region of interest in the sample 207. The provided device and methods can minimize reagent use and may allow different reagents (e.g., probe panels) to be delivered for different regions (e.g., the region indicated by 217) of the sample 207.

The present invention is not intended to be limited in scope to the particular disclosed embodiments, which are provided, for example, to illustrate various aspects of the invention. Various modifications to the compositions and methods described will become apparent from the description and teachings herein. Such variations may be practiced without departing from the true scope and spirit of the disclosure and are intended to fall within the scope of the present disclosure.

What is claimed is:

1. A device comprising
a first directing channel comprising a first directing proximal portion and a first directing distal portion;
a second directing channel comprising a second directing proximal portion and a second directing distal portion;
an inlet channel comprising an inlet proximal portion and an inlet distal portion;
a reaction chamber; and
a waste outlet,
wherein:
the inlet distal portion is disposed between the first directing distal portion and the second directing distal portion;
the first directing channel, the second directing channel, and the inlet channel are in fluid communication with the reaction chamber; and
the waste outlet is in fluid communication with the reaction chamber.

2. The device of claim 1, further comprising at least one reagent channel in fluid communication with the inlet channel.

3. The device of claim 2, further comprising at least one reagent reservoir in fluid communication with the at least one reagent channel.

4. The device of claim 3, wherein the at least one reagent channel comprises a plurality of reagent channels.

5. The device of claim 4, wherein the at least one reagent reservoir comprises a plurality of reagent reservoirs, and each reagent reservoir of the plurality of reagent reservoirs is in fluid communication with a corresponding reagent channel of the plurality of reagent channels.

6. The device of claim 4, wherein each reagent channel of the plurality of reagent channels is in fluid communication with the inlet channel.

7. The device of claim 1, wherein the first directing distal portion and the second directing distal portion are each disposed at a distance of about 100 μm to about 5 mm from the inlet channel.

8. The device of claim 1, further comprising an inlet region, wherein:
the first directing distal portion, the second directing distal portion, and the inlet distal portion are in fluid communication with the inlet region; and
the inlet region is in fluid communication with the reaction chamber.

9. The device of claim 1, wherein the first directing distal portion, the second directing distal portion, and the inlet distal portion are in fluid communication with a proximal side of the reaction chamber, and the waste outlet is in fluid communication with a distal side of the reaction chamber.

10. The device of claim 1, further comprising a first directing reservoir in fluid communication with the first directing proximal portion and/or a second directing reservoir in fluid communication with the second directing proximal portion.

11. The device of claim 1, further comprising at least one valve disposed along at least one of: the first directing distal portion, the second directing distal portion, and the inlet channel.

12. The device of claim 1, further comprising at least one valve disposed along the waste outlet.

13. The device of claim 1, wherein the device is a microfluidic device.

14. A method for directing flow in a reaction chamber, comprising:
providing a device comprising:
a first directing channel comprising a first directing proximal portion and a first directing distal portion,
a second directing channel comprising a second directing proximal portion and a second directing distal portion,
an inlet channel comprising an inlet proximal portion and an inlet distal portion,
a reaction chamber comprising a sample, and
a waste outlet,
wherein the inlet distal portion is disposed between the first directing distal portion and the second directing distal portion;
the first directing distal portion, the second directing distal portion, and the inlet distal portion are in fluid communication with the reaction chamber; and
the waste outlet is in fluid communication with the reaction chamber;
flowing a first liquid from the inlet channel to the reaction chamber at a first flow rate, flowing a second liquid from the first directing channel to the reaction chamber at a second flow rate, and flowing a third liquid from the second directing channel to the reaction chamber at a third flow rate, wherein the first, second, and third flow rates direct the first liquid to a first region of interest of the sample, and wherein the first region of interest is smaller than area of the sample.

15. The method of claim 14, wherein the device further comprises at least one reagent channel in fluid communication with the inlet channel.

16. The method of claim 15, wherein the device further comprises at least one reagent reservoir in fluid communication with the at least one reagent channel.

17. The method of claim 16, wherein the at least one reagent channel comprises a plurality of reagent channels.

18. The method of claim 17, wherein the at least one reagent reservoir comprises a plurality of reagent reservoirs, and each reagent reservoir of the plurality of reagent reservoirs is in fluid communication with a corresponding reagent channel of the plurality of reagent channels.

19. The method of claim 18, wherein each reagent channel of the plurality of reagent channels is in fluid communication with the inlet channel.

20. The method of claim 14, wherein the first directing distal portion and the second directing distal portion are each disposed at a distance of about 100 μm to about 5 mm from the inlet channel.

21. The method of claim 14, wherein the device further comprises an inlet region, wherein:
the first directing distal portion, the second directing distal portion, and the inlet distal portion are in fluid communication with the inlet region; and
the inlet region is in fluid communication with the reaction chamber.

22. The method of claim 14, wherein the first directing distal portion, the second directing distal portion, and the inlet distal portion are in fluid communication with a proximal side of the reaction chamber, and the waste outlet is in fluid communication with a distal side of the reaction chamber.

23. The method of claim 14, wherein the device further comprises a first directing reservoir in fluid communication with the first directing proximal portion and/or a second directing reservoir in fluid communication with the second directing proximal portion.

24. The method of claim 14, wherein the device further comprises at least one valve disposed along at least one of: the first directing distal portion, the second directing distal portion, and the inlet channel.

25. The method of claim 14, wherein the device further comprises at least one valve disposed along the waste outlet.

26. The method of claim 14, wherein the reaction chamber comprises a lid that is separable from the device.

27. The method of claim 14, wherein the reaction chamber comprises an optically transparent window.

28. The method of claim 14, wherein the device is a microfluidic device.

29. The method of claim 14, further comprising flowing one or more additional liquids from the inlet channel to the reaction chamber at the first flow rate, flowing the second liquid from the first directing channel to the reaction chamber at the second flow rate, and flowing the third liquid from the second directing channel to the reaction chamber at the third flow rate, wherein the first, second, and third flow rates direct the one or more additional liquids to the first region of interest.

30. The method of claim 14, wherein the first liquid comprises a reagent for detecting a nucleic acid in the sample.

31. The method of claim 30, wherein the reagent is for a nucleic acid sequencing reaction.

32. The method of claim 31, wherein the reagent is for a DNA sequencing reaction or an RNA sequencing reaction.

33. The method of claim 30, wherein the reagent is for in situ hybridization (ISH).

34. The method of claim 33, wherein the reagent is for fluorescence in situ hybridization (FISH).

35. The method of claim 14, wherein the first liquid comprises a reagent for detecting a protein in the sample.

36. The method of claim 35, wherein the reagent is for immunohistochemistry (IHC).

37. The method of claim 14, wherein the first liquid comprises a reagent for an enzymatic reaction.

38. The method of claim 14, wherein the first liquid comprises a reagent for a chemical reaction.

39. The method of claim 30, wherein reagents are selected from the group consisting of antibodies, buffers, enzymes, chelators, nucleotides, oligonucleotides, dyes, chemical crosslinkers, permeabilization reagents, clearing reagents, quenchers, and salts.

40. The method of claim 35, wherein reagents are selected from the group consisting of antibodies, buffers, enzymes, chelators, nucleotides, oligonucleotides, dyes, chemical crosslinkers, permeabilization reagents, clearing reagents, quenchers, and salts.

41. The method of claim 39, wherein enzymes are selected from the group consisting of polymerases, ligases, nuclease inhibitors, and proteases.

42. The method of claim 39, wherein oligonucleotides comprise primers and/or nucleic acid probes.

43. The method of claim 42, wherein the nucleic acid probes are detectably labeled.

44. The method of claim 14, wherein the first liquid is miscible with water.

45. The method of claim 14, wherein the second and third liquids are not miscible with water.

46. The method of claim 14, wherein the first liquid is not miscible with the second liquid or the third liquid.

47. The method of claim 14, wherein the second and third liquids are the same.

48. The method of claim 14, wherein the sample can be removed from the reaction chamber.

49. The method of claim 14, wherein the sample is a biological sample.

50. The method of claim 49, wherein the biological sample is a tissue sample.

51. The method of claim 14, wherein the method further comprises taking one or more measurements of the first region of interest.

52. The method of claim 14, wherein the sample further comprises a second region of interest, and the method further comprises flowing the first liquid from the inlet channel to the reaction chamber at a fourth flow rate, flowing the second liquid from the first directing channel to the reaction chamber at a fifth flow rate, and flowing the third liquid from the second directing channel to the reaction chamber at the sixth flow rate, wherein the fourth, fifth, and sixth flow rates direct the first liquid to the second region of interest.

53. The method of claim 52, wherein the method further comprises taking one or more measurements of the second region of interest.

54. The method of claim 52, wherein:
the first and fourth flow rates are different;
the second and fifth flow rates are different; and/or
the third and sixth flow rates are different.

55. A system for directing the flow of one or more liquids, comprising:
a device comprising:
a first directing channel comprising a first directing proximal portion and a first directing distal portion,
a second directing channel comprising a second directing proximal portion and a second directing distal portion,
an inlet channel comprising an inlet proximal portion and an inlet distal portion,
a reaction chamber, and
a waste outlet;
a controller capable of controlling the flow rate of liquids into the device; and
a computing device operatively linked to the device and the controller, and wherein the computing device is configured to control the flow rate of a first liquid in the inlet channel, the flow rate of a second liquid in the first directing channel, and the flow rate of a third liquid in second directing channel to direct the flow of the first liquid to a first region of interest of a sample in the reaction chamber, and wherein the first region of interest is smaller than the area of the reaction chamber.

56. The system of claim 55, wherein the device further comprises at least one reagent channel in fluid communication with the inlet channel.

57. The system of claim 56, wherein the device further comprises at least one reagent reservoir in fluid communication with the at least one reagent channel.

58. The system of claim 57, wherein the at least one reagent channel comprises a plurality of reagent channels.

59. The system of claim 58, wherein the at least one reagent reservoir comprises a plurality of reagent reservoirs, and each reagent reservoir of the plurality of reagent reservoirs is in fluid communication with a corresponding reagent channel of the plurality of reagent channels.

60. The system of claim 59, wherein each reagent channel of the plurality of reagent channels is in fluid communication with the inlet channel.

61. The system of claim 55, wherein the first directing distal portion and the second directing distal portion are each disposed at a distance of about 100 μm to about 5 mm from the inlet channel.

62. The system of claim 55, wherein the device further comprises an inlet region, wherein:
the first directing distal portion, the second directing distal portion, and the inlet distal portion are in fluid communication with the inlet region; and
the inlet region is in fluid communication with the reaction chamber.

63. The system of claim 55, wherein the first directing distal portion, the second directing distal portion, and the inlet distal portion are in fluid communication with a proximal side of the reaction chamber, and the waste outlet is in fluid communication with a distal side of the reaction chamber.

64. The system of claim 55, wherein the device further comprises a first directing reservoir in fluid communication with the first directing proximal portion and/or a second directing reservoir in fluid communication with the second directing proximal portion.

65. The system of claim 55, wherein the device further comprises at least one valve disposed along at least one of: the first directing distal portion, the second directing distal portion, and the inlet channel.

66. The system of claim 55, wherein the device further comprises at least one valve disposed along the waste outlet.

67. The system of claim 55, wherein the reaction chamber comprises a lid that is separable from the device.

68. The system of claim 55, wherein the reaction chamber comprises an optically transparent window.

69. The system of claim 55, wherein the device is a microfluidic device.

70. The system of claim 55, further comprising a computing device comprising a user interface for selecting the first region of interest in the reaction chamber.

71. The system of claim 55, wherein:
the inlet channel comprises a first liquid;
the first directing channel comprises a second liquid; and
the second directing channel comprises a third liquid, and wherein the first liquid is immiscible with the second and third liquids.

72. The system of claim 71, wherein the sample further comprises a second region of interest, and wherein the computing device is configured to control the flow rate of a first liquid in the inlet channel, the flow rate of a second liquid in the first directing channel, and the flow rate of a third liquid in second directing channel to direct the flow of the first liquid to a second region of interest in the reaction chamber, wherein the second region of interest is smaller than the area of the reaction chamber, and wherein the second region of interest is different from the first region of interest.
